(19) United States
(12) Patent Application Publication
(10) Pub. No.: US 2023/0169274 A1
(43) Pub. Date: Jun. 1, 2023

(54) SYSTEMS AND METHODS FOR INTENT RESPONSE SOLICITATION AND PROCESSING

(71) Applicant: LIVEPERSON, INC., New York, NY (US)

(72) Inventors: Goor Cohen, Ramat Hasharon (IL); Shai Aviram, Kfar-Saba (IL); Avi Kedmi, New York, NY (US)

(73) Assignee: LIVEPERSON, INC., New York, NY (US)

(21) Appl. No.: 18/096,110

(22) Filed: Jan. 12, 2023

Related U.S. Application Data
(63) Continuation-in-part of application No. 17/336,674, filed on Jun. 2, 2021, now abandoned.
(60) Provisional application No. 63/033,534, filed on Jun. 2, 2020.

(51) Int. Cl. G06F 40/35; H04L 51/04

(52) U.S. Cl. CPC G06F 40/35; H04L 51/04

(57) ABSTRACT

Disclosed embodiments provide a framework to solicit and evaluate responses from different systems and other users to the intents communicated by requesting users. In response to obtaining an intent, an intent messaging service provides the intent to a selected system to solicit a response to the intent. In response to obtaining an intent response, the intent messaging service prohibits the system from generating further intent responses and provides the obtained intent response to the requesting user. The intent messaging service establishes a communications session between the requesting user and the system in response to another request corresponding to the intent. This allows for additional responses to be provided to the requesting user by the system identified by the intent messaging service.

### CROSS-REFERENCE TO RELATED APPLICATIONS

The present patent application is a continuation-in-part of U.S. patent application Ser. No. 17/336,674 filed Jun. 2, 2021, which claims the priority benefit of U.S. provisional patent application No. 63/033,534 filed Jun. 2, 2020, the disclosures of which are incorporated by reference herein.

### FIELD

The present disclosure relates generally to systems and methods for facilitating communications sessions between users and other systems. More specifically, techniques are provided to deploy a framework to solicit and evaluate responses from other systems and other users to the intents communicated by users.

### SUMMARY

Disclosed embodiments provide a framework for an intent processing system that facilitates communications sessions between users and other systems and entities, whereby the intent processing system can solicit and evaluate responses from these other systems, entities, and other users to intents communicated by these users. According to some embodiments, a computer-implemented method is provided. The computer-implemented method comprises obtaining an intent. The intent is associated with a requesting user. The computer-implemented method further comprises generating in real-time a dataset. The dataset includes sample intents, sample outputs, and feedback corresponding to the sample outputs. The sample outputs correspond to features associated with a set of other users that are provided with the sample intents. Further, the dataset is generated in real-time as the feedback is obtained. The computer-implemented method further comprises dynamically training in real-time a machine learning algorithm to identify different users for soliciting responses to different intents. The machine learning algorithm is dynamically trained using the dataset as the feedback is obtained. The computer-implemented method further comprises processing the intent through the machine learning algorithm to identify one or more users for soliciting responses to the intent. The computer-implemented method further comprises obtaining in real-time an intent response. The intent response is associated with a particular user from the one or more users. The computer-implemented method further comprises providing the intent response. The intent response is provided as a result of a determination that the intent response is relevant to the intent. The computer-implemented method further comprises facilitating a communications session between the requesting user and the particular user. The communications session is facilitated in response to input corresponding to the intent response. The computer-implemented method further comprises dynamically updating the dataset in real-time using the intent and features corresponding to particular user. The computer-implemented method further comprises updating in real-time the machine learning algorithm using the dynamically updated dataset.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which an intent messaging service obtains an intent from a user and presents the user with responses to the intent from other systems, entities, and other users in accordance with at least one embodiment;

FIG. 2 shows an illustrative example of an environment in which an intent messaging service identifies other systems, entities, and other users to solicit responses to an intent submitted by a user in accordance with at least one embodiment;

FIG. 3 shows an illustrative example of an environment in which an intent extraction algorithm dynamically, and in real-time, processes an incoming request associated with a user to extract an intent associated with the incoming request in accordance with at least one embodiment;

FIG. 4 shows an illustrative example of an environment in which an entity selection algorithm dynamically, and in real-time, selects one or more other systems and other users from which to solicit responses to an intent associated with a user request in accordance with at least one embodiment;

FIG. 5 shows an illustrative example of an environment in which a response evaluation algorithm dynamically, and in real-time, evaluates responses from other systems and/or other users for a particular intent to automatically provide relevant responses for the particular intent in accordance with at least one embodiment;

FIG. 6 shows an illustrative example of an environment in which a user, via a user interface, generates an intent to solicit a response from other systems, entities, and other users of an intent messaging service in accordance with at least one embodiment;

FIG. 7 shows an illustrative example of an environment in which a user is provided with a status with regard to an intent submitted by the user via a user interface in accordance with at least one embodiment;

FIG. 8 shows an illustrative example of an environment in which another system or entity is provided with a new intent from a user via a user interface of an intent messaging application utilized by the other system or entity to access various user intents in accordance with at least one embodiment;

FIG. 9 shows an illustrative example of an environment in which another system or entity, via a user interface of an intent messaging application utilized by the other system or entity, provides a response to an intent of a user in accordance with at least one embodiment;

FIG. 10 shows an illustrative example of an environment in which another system or entity is authorized to communicate directly with a user as a result of the user requesting establishment of a communications session between the user and the other system or entity in accordance with at least one embodiment;

FIG. 11 shows an illustrative example of an environment in which a communications session between another system or entity and a user is established by the intent messaging service to enable direct communication between the other system or entity and the user via an intent messaging application in accordance with at least one embodiment;

FIG. 12 shows an illustrative example of a process for broadcasting an intent to one or more other systems and entities without providing identifying information of a user that submitted the intent in accordance with at least one embodiment;

FIG. 13 shows an illustrative example of a process for obtaining an intent response from another system or entity and evaluating the intent response to determine the relevance of the intent response to the intent in accordance with at least one embodiment;

FIG. 14 shows an illustrative example of a process for establishing a communications session between a user and another system or entity in response to a request from the user to initiate a conversation with the other system or entity in accordance with at least one embodiment; and

FIG. 15 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing a preferred examples of embodiment. It is understood that various changes can be made in the function and arrangement of elements without departing from the spirit and scope as set forth in the appended claims.

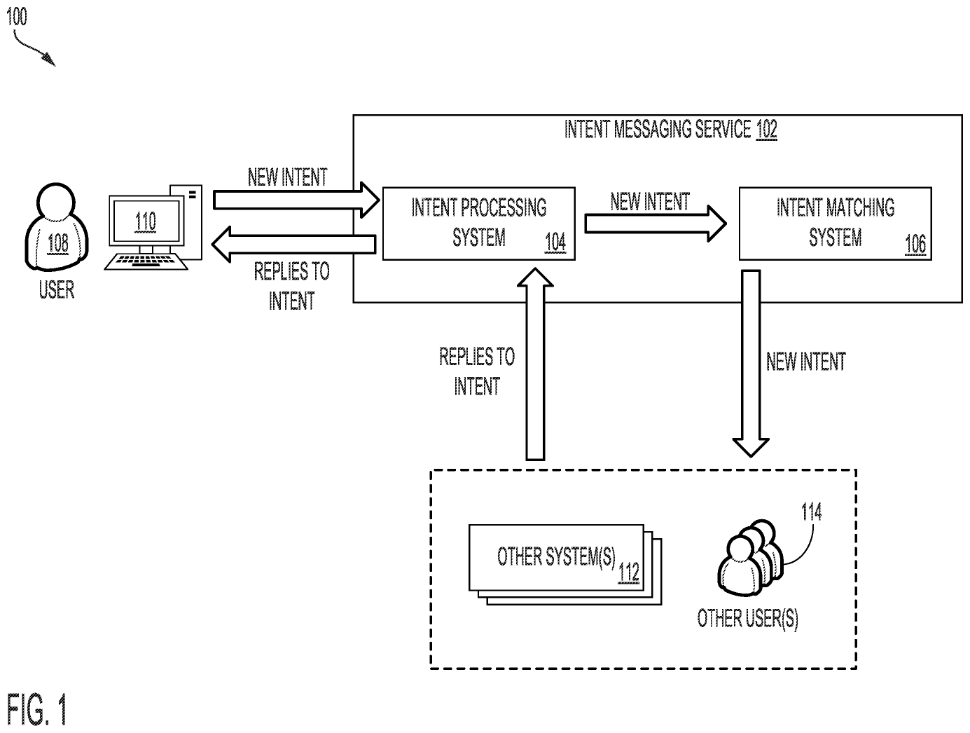

FIG. 1 shows an illustrative example of an environment 100 in which an intent messaging service 102 obtains an intent from a user 108 and presents the user 108 with responses to the intent from other systems 112 and other users 114 in accordance with at least one embodiment. In the environment 100, a user 108, via an intent messaging application implemented on a computing device 110, transmits a request to an intent processing system 104 of an intent messaging service 102 to obtain one or more responses to the request from one or more other systems 112 and/or other users 114 associated with the intent messaging service 102. The one or more other systems 112 may correspond to entities engaged in particular endeavors, such as the providing goods and/or services to users in a different settings. The other users 114 may include members of the intent messaging service 102 community that may also interact with the one or more other systems 112 to obtain responses to their intents and that may have experience with regard to various topics, goods, services, or other areas of interest that may be associated with intents. The intent messaging application implemented on the computing device 110 may be provided by the intent messaging service 102 to allow users, such as user 108, to interact with other systems 112 and other users 114 that are associated with the intent messaging service 102 (e.g., community of users that utilize the intent messaging service 102) and may provide goods and services to users. The intent messaging service 102 may provide a platform for users and other systems to connect in order to provide recommendations and advice with regard to intents submitted by these users.

In response to obtaining a request from a user 108, the intent processing system 104 may evaluate the request to extract an intent expressed by the user 108 and that may be used to identify the other systems 112 and other users 114 that may provide relevant responses to the user's request. In an embodiment, the intent processing system 104 implements a machine learning algorithm or artificial intelligence that is dynamically trained in real-time to process the request in order to identify and extract the intent from the request. The machine learning algorithm or artificial intelligence may be used to perform a semantic analysis of the request (e.g., by identifying keywords, sentence structures, repeated words, punctuation characters and/or non-article words) to identify the intent expressed in the request. For instance, the machine learning algorithm or artificial intelligence can include natural language processing (NLP) and/or other forms of conversational algorithms and systems that are dynamically trained in real-time to process the request, as communicated by the user 108 through the intent processing system 104. In some examples, the machine learning algorithm or artificial intelligence can be dynamically trained to perform, in real-time, a semantic analysis of user communications to the intent processing system 104 (e.g., by identifying keywords, sentence structures, repeated words, punctuation characters and/or non-article words, etc.) as these user communications are exchanged to identify the intent expressed by the user 108 in their request.

The machine learning algorithm or artificial intelligence utilized by the intent processing system 104 may be dynamically trained in real-time using supervised learning techniques. For instance, a dataset of input requests (e.g., historical input requests submitted by different users associated with the intent messaging service 102, hypothetical input requests generated for training of the machine learning algorithm or artificial intelligence, etc.) and known intents associated with the input requests (e.g., historical intents associated with historical input requests, hypothetical intents associated with hypothetical input requests, etc.) can be selected for training of the machine learning algorithm or artificial intelligence. In some implementations, known intents used to train the machine learning model may include different characteristics associated with these known intents. For example, the different characteristics may include known keywords commonly associated with particular known intents. The different characteristics may further include particular sentence structures, repeated words, or other identifying features that may be indicative of particular known intents.

The machine learning algorithm or artificial intelligence may be evaluated in real-time to determine, based on the sample input requests supplied to the machine learning algorithm or artificial intelligence, whether the machine learning algorithm or artificial intelligence is accurately extracting the expected intents from each of these sample input requests. Based on this evaluation, the machine learning algorithm or artificial intelligence may be re-trained or otherwise updated to increase the likelihood of the machine learning algorithm or artificial intelligence generating the desired results. The machine learning algorithm or artificial intelligence may further be dynamically trained by soliciting feedback from users, including user 108, with regard to extracted intents obtained from submitted requests. For instance, prior to submitting an extracted intent for identification of one or more other systems 112 or other users 114 from which to solicit responses to the intent, the extracted intent may be presented to the user 108 to determine whether the extracted intent corresponds to the request submitted by the user 108. The response from the user 108 may, thus, be utilized to train the machine learning algorithm or artificial intelligence based on the accuracy of the machine learning algorithm or artificial intelligence in identifying the intent from the request.

It should be noted that the machine learning algorithm or artificial intelligence implemented to extract and identify the intent communicated by users in their requests to the intent messaging service 102 is dynamically trained, in real-time, as intents are extracted from incoming requests associated with different users associated with the intent messaging service 102. For example, the machine learning algorithm or artificial intelligence may simultaneously, and continuously, process communications exchanged between different users and the intent processing system 104 to extract any intents expressed by these users. Further, as these intents are presented to these users, any feedback received corresponding to these myriad intents may be used to dynamically, and in real-time, re-train or otherwise update the machine learning algorithm or artificial intelligence. Thus, as users continuously communicate with the intent messaging service 102 to submit their requests, the machine learning algorithm or artificial intelligence, in real-time, may continuously extract corresponding intents and may continuously be re-trained or otherwise updated as feedback is received corresponding to these intents. This allows for the machine learning algorithm or artificial intelligence to constantly process communications exchanged between different users and the intent processing service 102 as these communications are received and extract corresponding intents expressed by these users. Further, this allows for the machine learning algorithm or artificial intelligence to be constantly updated in real-time based on feedback corresponding to these intents and as new communications are constantly being processed by the machine learning algorithm or artificial intelligence.

An intent may correspond to an issue that a user wishes to have resolved. Examples of intents can include (for example) topic, sentiment, complexity, and urgency. A topic can include, but is not limited to, a subject, a product, a service, a technical issue, a use question, a complaint, a refund request or a purchase request, etc. An intent can be determined, for example, based on a semantic analysis of a message (e.g., by identifying keywords, sentence structures, repeated words, punctuation characters and/or non-article words); user input (e.g., having selected one or more categories); and/or message-associated statistics (e.g., typing speed and/or response latency).

The intent processing system 104 may provide the extracted intent to an intent matching system 106 of the intent messaging service 102. The intent matching system 106 may be implemented on a computing system or other system (e.g., server, virtual machine instance, etc.) of the intent messaging service 102. Alternatively the intent matching system 106 may be implemented as an application or other process executed on a computing system of the intent messaging service 102. In some instances, the intent matching system 106 may be a special purpose computing device that includes tailored components for performing the operations described herein.

In an embodiment, in response to obtaining a new intent from the intent processing system 104, the intent matching system 106 utilizes the new intent, as well as information regarding different systems 112 and other users 114 associated with the intent messaging service 102, as input to a machine learning algorithm or artificial intelligence to identify one or more other systems 112 and/or other users 114 that are likely to provide relevant responses to the intent. The information regarding the different systems 112 and other users 114 may include historical data corresponding to responses submitted by the different systems 112 and other users 114 to previously provided intents. The historical data may indicate another system's or other user's performance in providing relevant responses to different intents submitted to the other system or other user, information regarding any prior interactions between the other system/other user and the user 108, user feedback (if any) related to a user's interaction with the other system or other user, and the like. Further, the information regarding another system or other user may specify the types of intents that the other system or other user may have expertise in responding to. For instance, the information may indicate what goods and services are provided by another system, what goods or services a user has utilized, or any other information that may be useful in identifying whether resolution of a particular intent may involve these goods and services.

The machine learning algorithm or artificial intelligence implemented by the intent matching system 106 may be dynamically trained in real-time using sample intents (e.g., historical intents extracted from historical requests submitted by different users, hypothetical intents, etc.) and sample outputs corresponding to known features of other systems 112 and other users 114 that may be used to identify the other systems 112 and other users 114 to which an intent is to be provided. Further, the machine learning algorithm or artificial intelligence may be dynamically trained in real-time using feedback from the different systems 112 and other users 114 receiving an intent, as this feedback is received. This feedback may be used to determine whether the machine learning algorithm or artificial intelligence is accurately selecting other systems 112 and other users 114 that are capable of responding to an intent with a relevant response or that are otherwise associated with a feature of an intent. This feedback may be used, in real-time and as the feedback is received, to further train the machine learning algorithm or artificial intelligence utilized by the intent matching system 106. Thus, the machine learning algorithm or artificial intelligence may be dynamically trained in real-time as feedback is obtained by the intent matching system 106 from different systems 112 and other users 114 for myriad intents submitted to these different systems 112 and other users 114.

It should be noted that the machine learning algorithm or artificial intelligence implemented to identify other systems 112 and/or other users 114 to which requests may be provided to solicit relevant responses to user intents is dynamically trained, in real-time, as different systems 112 and/or other users 114 are selected for solicitation of responses to these user intents. For example, the machine learning algorithm or artificial intelligence may simultaneously, and continuously, process intents associated with different users to select different systems 112 and/or other users 114 that may be capable of responding to these intents. Further, as the requests corresponding to these intents are presented to these different systems 112 and/or other users 114, any feedback received corresponding to these myriad requests and corresponding intents may be used to dynamically, and in real-time, re-train or otherwise update the machine learning algorithm or artificial intelligence. Thus, as different intents are extracted from corresponding requests in real-time as these requests are received, the machine learning algorithm or artificial intelligence, in real-time, may continuously select different systems 112 and/or other users 114 to which these intents may be provided in order to solicit responses to these intents and may continuously be re-trained or otherwise updated as feedback is received corresponding to the selection of these different systems 112 and/or other users 114. This allows for the machine learning algorithm or artificial intelligence to constantly process intents associated with different users as these intents are dynamically extracted by the intent processing system 104 through the aforementioned machine learning algorithm or artificial intelligence implemented to dynamically extract intents from exchanged communications in real-time. Further, this allows for the machine learning algorithm or artificial intelligence to be constantly updated in real-time based on feedback corresponding to the selection of different systems 112 and/or other users 114 and as new intents are constantly being processed by the machine learning algorithm or artificial intelligence.

The output of the machine learning algorithm or artificial intelligence implemented by the intent matching system 106 may include identifiers corresponding to the one or more other systems 112 and/or other users 114 to which the new intent is to be provided in order to solicit responses from each of the one or more other systems 112 and/or other users 114. The new intent may be assigned a unique identifier such that responses obtained from the one or more other systems 112 and/or other users 114 may be associated with the particular intent by reference to the unique identifier. In an embodiment, the intent matching system 106 updates the user interface of the intent messaging application utilized by each other system 112 or other user 114 to indicate a solicitation of a response to a particular intent. For instance, through this user interface, the intent matching system 106 may present an agent associated with the other system 112 or other user 114 with the new intent, as well as options for responding to the intent. An agent associated with the other system 112 or other user 114, via this user interface, may respond to the intent, reject/ignore the intent, or provide an indication to the intent matching system 106 that the intent is not relevant to the other system 112 or other user 114. The action performed by the agent associated with the other system 112 or other user 114 may be used to further dynamically and in real-time re-train or otherwise update the machine learning algorithm or artificial intelligence implemented by the intent matching system 106 to select different systems 112 and/or other users 114 for responding to intents. For instance, if an agent associated with another system 112 indicates that a provided intent is not relevant to the other system 112, the intent matching system 106 may utilize this feedback to re-train or otherwise update the machine learning algorithm or artificial intelligence such that similar intents are not provided to the other system 112.

In an embodiment, another system 112 (e.g., an agent associated with the other system that is assigned to interact with the intent messaging service 102) or other user 114 receiving an intent for which a response is being solicited is restricted to a single response to the intent. For instance, when an agent associated with another system 112 or other user 114 submits a response to an intent to the intent processing system 104, the intent messaging application utilized by the agent associated with the other system 112 or other user 114 may automatically disable the ability to submit additional responses to the intent until the user 108 has indicated that they wish to engage further with the other system 112 or other user 114 with regard to the intent. This may prevent the other system 112 or other user 114 from inundating (e.g., “spamming”) the user 108 with responses to the intent. Further, should a user 108 refuse to engage with the other system 112 or other user 114, the user 108 may be spared from additional responses from the other system 112 or other user 114.

In an embodiment, when the intent processing system 104 receives a response to a particular intent from another system 112 or other user 114, the intent processing system 104 transmit one or more executable instructions to the intent messaging application utilized to transmit the response to prohibit entry of additional responses to the intent. For instance, through one or more application programming interfaces (APIs), the intent processing system 104 may transmit these one or more executable instructions to the intent messaging application. In response to receiving these executable instructions, the intent messaging application may automatically execute these executable instructions in order to prevent an agent associated with the other system 112 or other user 114 to enter or otherwise submit additional responses to the intent.

If an agent associated with another system 112 or other user 114 submits an intent response to the intent processing system 104 for the user 108, the intent processing system 104 may automatically, and in real-time, evaluate the intent response to determine whether the intent response is relevant to the intent submitted by the user 108. In an embodiment, the intent processing system 104 implements a classification algorithm or other machine learning algorithm that is dynamically trained, in real-time, to automatically classify an intent response as either being relevant to a particular intent or irrelevant to the particular intent. The classification algorithm or other machine learning algorithm implemented by the intent processing system 104 may be dynamically trained, in real-time, using supervised learning techniques. For instance, a dataset of input intents, known relevant responses, known irrelevant responses, and corresponding classifications, can be selected for training of the classification algorithm or other machine learning algorithm. In some examples, the input intents can be obtained from administrators of the intent messaging service 102, users associated with the intent messaging service 102, or other sources associated with the intent messaging service 102. In some implementations, known relevant and irrelevant responses used to train the classification algorithm or other machine learning algorithm implemented by the intent processing system 104 include responses generated by the entities that generated the sample intents. Further, the classification algorithm or other machine learning algorithm used to classify intent responses as being relevant or irrelevant may be dynamically trained using feedback from users, including user 108. For instance, if a response classified as being relevant to an intent is provided to a user 108, the user 108 may provide feedback indicating whether the response was indeed relevant to the intent. This feedback may be used to either reinforce the model (e.g., a response classified as being relevant was deemed relevant to the intent by the user 108) or to update the model (e.g., a response classified as being relevant was deemed to be irrelevant to the intent by the user 108). As users associated with the intent messaging service 102 provide their feedback to the intent messaging service 102, the classification algorithm or other machine learning algorithm may be dynamically updated in real-time.

The intent processing system 104, using the classification algorithm or machine learning algorithm described above, may automatically discard any responses classified as being irrelevant to the intent. In an embodiment, if the intent processing system 104 determines that another system 112 or other user 114 has provided an irrelevant response to an intent, the intent processing system 104 updates the profile of the other system 112 or other user 114 to indicate that the other system 112 or other user 114 has provided an irrelevant response to the intent. This may reduce the likelihood of the other system 112 or other user 114 from being selected by the intent matching system 106 to respond to similar intents. In some instances, this feedback may also be used to dynamically train the machine learning algorithm or other artificial intelligence implemented by the intent matching system 106 to further reduce the likelihood of the other system 112 or other user 114 being solicited to provide responses to similar intents. If the other system 112 or other user 114 is deemed to be providing irrelevant responses on a consistent basis (e.g., at a rate that surpasses a threshold frequency, etc.), other remedial operations may be performed, such as suspending, disassociating, or removing the other system 112 or other user 114 from the intent messaging service 102.

It should be noted that the intent processing system 104, through the classification algorithm or machine learning algorithm described above, can automatically process any responses to different intents in real-time and as these responses are received from myriad other systems 112 and other users 114. This allows the classification algorithm or machine learning algorithm to process, in real-time, multiple responses simultaneously from different systems 112 and other users 114 and corresponding to any number of different intents. As a result, the intent processing system 104, through the classification algorithm or machine learning algorithm may continuously, and in real-time, determine the relevance of received responses to different intents and provide any relevant responses to different intents to their corresponding users (e.g., user 108, etc.), as described herein. This allows for the intent processing system 104, through the classification algorithm or machine learning algorithm to constantly process responses to different responses from different systems 112 and other users 114 as these responses are received to determine the relevance of these responses to corresponding intents. Further, this allows the classification algorithm or machine learning algorithm to be constantly updated in real-time based on feedback corresponding to the relevancy of any provided responses and as new responses are constantly being processed by the classification algorithm or machine learning algorithm.

If the intent processing system 104 determines that a relevant response to an intent has been obtained, the intent processing system 104 may provide this response to the user 108 via the intent messaging application implemented and executed on the computing device 110. This may cause the intent response to be displayed on a user interface of the computing device 110. Through this user interface, the user 108 may evaluate the intent response and determine whether to engage further with the other system 112 or other user 114, thank or express gratitude to the other system 112 or other user for the response, or ignore the intent response. Additionally, the user 108 may provide feedback to the intent processing system 104 with regard to the quality of the intent response. This feedback may be utilized to further dynamically re-train or otherwise update, in real-time, the machine learning algorithm or artificial intelligence implemented by the intent matching system 106 used to identify other systems 112 and other users 114 to which intents are provided to solicit responses to the intents.

In an embodiment, if the user 108 determines that they want to communicate with another system 112 or other user 114 further with regard to the intent submitted by the user 108, the intent messaging service 102 establishes a communications session between the user 108 and the other system 112 or other user 114 through which the user 108 and the other system 112 or other user 114 may exchange communications and/or other content. As noted above, when another system 112 or other user 114 submits a response to an intent, the intent messaging application utilized by the other system 112 or other user 114 may prohibit the other system 112 or other user 114 from submitting additional responses. In an embodiment, if the user 108 indicates that they wish to establish a communications session with the other system 112 or other user 114 with regard to the intent, the intent messaging service 102 may transmit one or more executable instructions to the intent messaging application associated with the other system 112 or other user 114 to enable the other system 112 or other user 114 to submit additional responses to the user 108 through the intent messaging application. Further, the intent messaging service 102 may provide the other system 112 or other user 114 with additional information regarding the user 108 (e.g., user name, user address, user images, user contact information, etc.).

To establish the communications session between the user 108 and the other system 112 or other user 114 that provided a relevant response to the user's intent, the intent processing system 104 transmit one or more executable instructions to the intent message application implemented by the other system 112 or other user 114 to enable the other system 112 or other user 114 to communicate with the user 108 through the communications session. For instance, through the aforementioned one or more APIs, the intent processing system 104 may transmit these one or more executable instructions to the intent messaging application. In response to receiving these one or more executable instructions, the intent messaging application may automatically execute these one or more executable instructions to allow an agent associated with the other system 112 or other user 114 to communicate with the user 108 through this communications session.

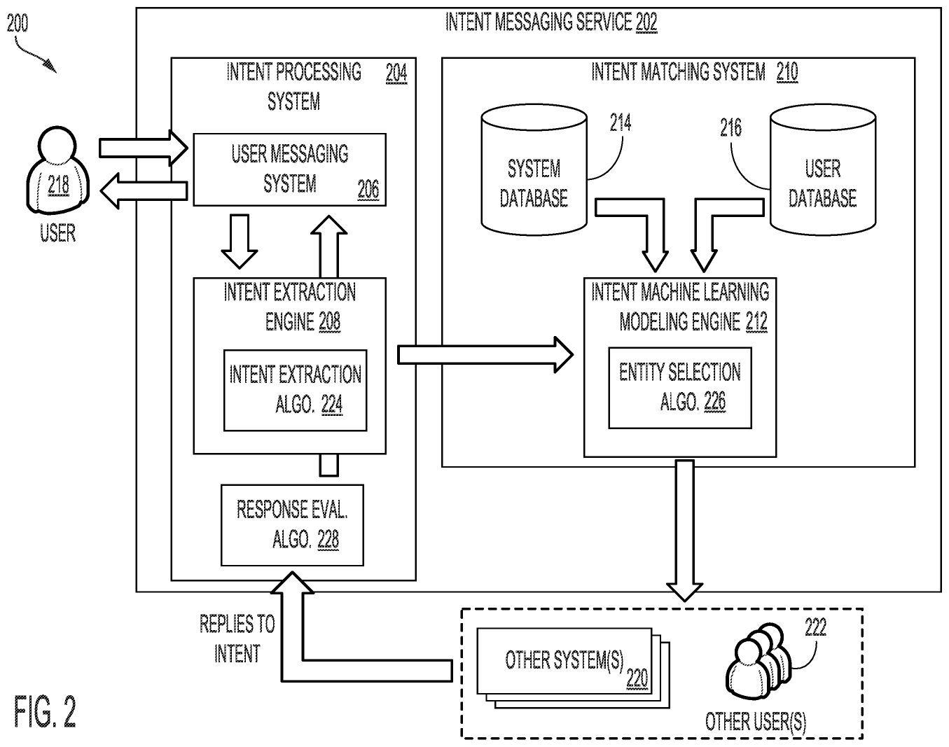

FIG. 2 shows an illustrative example of an environment 200 in which an intent messaging service 202 identifies other systems 220 and other users 222 to solicit responses to an intent submitted by a user 218 in accordance with at least one embodiment. In the environment 200, the intent messaging service 202 obtains a request from a user 218 to solicit responses from one or more other systems 220 and/or other users 222 with regard to a particular intent. For instance, the user 218, using an intent messaging application installed on a computing device utilized by the user 218 or otherwise accessed by the user 218 using the computing device (e.g., via a website, etc.), may generate the request and indicate, in the request, the intent for which the user 218 is seeking relevant responses. The intent may (for example) be a topic, sentiment, complexity, and/or level of urgency. A topic can include, but is not limited to, a subject, a product, a service, a technical issue, a use question, a complaint, a refund request or a purchase request, etc.

The user 218, via the intent messaging application, may transmit their request and corresponding intent to a user messaging system 206 of an intent processing system 204. The user messaging system 206 may be implemented on a computing system of the intent messaging service 202 or as an application executed by a computing system of the intent processing system 204. In some instances, the user messaging system 206 may be a special purpose computing system or device that includes one or more specially configured components that, when implemented, may perform the operations described herein. The user messaging system 206 may facilitate communications between the user 218 and the intent messaging service 202 and any other systems 220 and/or other users 222 associated with the intent messaging service 202. For instance, the user messaging system 206 may establish a communications session with any other system 220 or other user 222 that the user 218 has selected to engage in a communications session via the intent messaging application concerning a particular intent. Further, the user messaging system 206 may serve to update the user interface of the intent messaging application based on the provided intent and responses obtained from the intent messaging service 202 identifying other systems 220 and other users 222 from which intent responses may be solicited for the particular intent.

In response to obtaining the request and corresponding intent from the user 218, the user messaging system 206 may transmit the request and corresponding intent to the intent extraction engine 208 of the intent processing system 204 to extract the intent from the request. The intent extraction engine 208 may be implemented as a computer system (such as a special purpose computer system that is configured and implemented to perform the operations described herein) that implements an intent extraction algorithm 224 that is dynamically trained, in real-time, to process an incoming request from a user 218 to identify the intent expressed in the request. For instance, the intent extraction algorithm 224 may be dynamically trained, in real-time, to perform a semantic analysis of the request (e.g., by identifying keywords, sentence structures, repeated words, punctuation characters and/or non-article words) to identify the intent expressed in the request. An intent can also be determined, for example, based on user input (e.g., having selected one or more categories); and/or communication-associated statistics (e.g., typing speed and/or response latency).

The intent extraction algorithm 224 implemented by the intent extraction engine 208 may be dynamically trained in real-time using supervised learning techniques. For instance, a dataset of input requests (e.g., historical input requests submitted by different users, hypothetical input requests generated for training of the intent extraction algorithm 224, etc.) and known intents included in the input requests (e.g., historical intents associated with historical input requests, hypothetical intents associated with hypothetical input requests, etc.) can be selected for training of the intent extraction algorithm 224 implemented by the intent extraction engine 208. In some examples, the input requests can be obtained from administrators of the intent messaging service 202, users associated with the intent messaging service 202, or other sources associated with the intent messaging service 202. In some implementations, known intents used to train the intent extraction algorithm 224 implemented by the intent extraction engine 208 may include characteristics of these intents provided by the entities that generated the sample requests. The intent extraction algorithm 224 may be evaluated to determine, based on the input sample requests supplied to the intent extraction algorithm 224, whether the intent extraction algorithm 224 is accurately extracting the expected intents from each of the sample requests. Based on this evaluation, the intent extraction algorithm 224 may be re-trained or otherwise updated in real-time (e.g., one or more parameters or variables associated with the intent extraction algorithm 224 may be updated) to increase the likelihood of the intent extraction algorithm 224 generating the desired results (e.g., expected intents).

In an embodiment, the intent extraction algorithm 224 is further dynamically trained in real-time as intents are extracted from incoming requests associated with different users associated with the intent messaging service 102. For example, the intent extraction algorithm 224 may simultaneously, and continuously, process communications exchanged between different users and the user messaging system 206 to extract any intents expressed by these users. Further, as these intents are presented to these users by the user messaging system 206, any feedback received corresponding to these myriad intents may be used to dynamically, and in real-time, re-train or otherwise update the intent extraction algorithm 224. Thus, as users continuously communicate with the user messaging system 206 to submit their requests, the intent extraction algorithm 224, in real-time, may continuously extract corresponding intents and may continuously be re-trained or otherwise updated as feedback is received corresponding to these extracted intents.

In an embodiment, the intent extraction engine 208 automatically and in real-time evaluates the request from the user 218 to determine whether additional information is required in order to extract or otherwise supplement the intent from the request in order to allow for identification of other systems 220 and/or other users 222 that may provide relevant responses to the intent. For instance, the intent extraction engine 208 may determine that the user's geographic location and timeframe for resolution of the intent are required. The intent extraction engine 208 may transmit a request to the user messaging system 206 to solicit this additional information from the user 218. In an embodiment, the user messaging system 206 implements NLP, interactive voice recognition systems, and/or other forms of conversational voice algorithms and systems to solicit the user 218 for the requested information. For example, using NLP, interactive voice recognition systems, and other forms of conversational voice algorithms and/or systems, the user messaging system 206 may prompt the user 218 to provide their location, the timeframe for resolution of the intent, which other users or other systems the user 218 would like to solicit responses from, and the like. Responses provided by the user 218 may be provided to the intent extraction engine 208, which may use these responses and the supplied request from the user 218 as input to the intent extraction algorithm 224 to extract, in real-time, the intent and supplement the intent with the additional information provided by the user 218. This may be used by the intent matching system 210 to identify the other systems 220 and/or other users 222 that may be solicited to obtain responses to the intent.

The intent extraction engine 208 may provide an extracted intent from the request submitted by the user 218 and identified by the intent extraction algorithm 224 to an intent machine learning modeling engine 212 of the intent matching system 210. The intent machine learning modeling engine 212 may be implemented on a computing system of the intent matching system 210 (such as a special purpose computer system that is configured and implemented to perform the operations described herein) or otherwise as an application or process executed on a computing system of the intent matching system 210. In an embodiment, the intent machine learning modeling engine 212 implements an entity selection algorithm 226 that is dynamically trained, in real-time, to identify other systems 220 and/or other users 222 to which an intent may be supplied in order to solicit responses to the intent. The entity selection algorithm 226 implemented by the intent machine learning modeling engine 212 may utilize information corresponding to the other systems 220 and other users 222 from a system database 214 and user database 216, respectively, maintained by the intent matching system 210, as well as the user's intent, as input to the entity selection algorithm 226 to identify one or more other systems 220 and/or one or more users 222 that are likely to provide relevant responses to the extracted intent. The system database 214 and user database 216 may include profiles of each of the other systems 220 and users 222, respectively, which may be associated with the intent messaging service 202. Each profile may indicate a user's or other system's experience responding to particular intents or categories of intents, as well as the user's or other system's interest in the underlying topic or classification of the intent. Further, each profile may indicate feedback with regard to a user's or other system's response to previously provided intents. This feedback may specify whether a response provided for a particular intent was relevant, useful, or otherwise appreciated by the user that submitted the request associated with the particular intent.

The user database 216 may further include a profile associated with the user 218. The profile of the user 218 may indicate any user preferences for particular other systems 220 or other users 222. For instance, the profile of the user 218 may specify which other systems 220 or other users 222 the user 218 has historically interacted with to address previously supplied intents. Further, for each of these interactions, the profile may include feedback from the user 218. This feedback may indicate whether interaction with a particular other system or other user was relevant to the corresponding intent, useful in addressing the corresponding intent, or otherwise conducive to a positive experience with the other system or other user. This information may also be utilized by the intent machine learning modeling engine 212, through the entity selection algorithm 226, to identify which other systems 220 and/or other users 222 to solicit responses to the intent.

The entity selection algorithm 226 implemented by the intent machine learning modeling engine 212 may be dynamically trained in real-time using sample intents (e.g., historical intents extracted from historical requests submitted by different users, hypothetical intents, etc.) and corresponding sample outputs (e.g., historical systems and/or users selected based on the historical intents, historical systems and/or users that have engaged in communications sessions with requesting users according to the historical intents, hypothetical systems and/or users selected based on the hypothetical intents, etc.) that may be used to identify the other systems 220 and other users 222 to which an intent is to be provided in order to solicit responses to the intent from these other systems 220 and other users 222. Further, the entity selection algorithm 226 may be dynamically trained in real-time using feedback from the different systems 220 and other users 222 receiving an intent. This feedback may be used to determine whether the entity selection algorithm 226 is accurately selecting other systems 220 and other users 222 that are likely to provide, for the extracted intent, a relevant response or that are otherwise associated with a feature of the extracted intent. For example, if another system that provides interior design services obtained an intent that is not related to interior design, the other system may provide feedback indicating that the provided intent is not relevant to the other system. This feedback may be used to further train the entity selection algorithm 226 implemented by the intent machine learning modeling engine 212.

It should be noted that the entity selection algorithm 226 implemented to identify other systems 220 and/or other users 222 to which requests may be provided to solicit relevant responses to user intents is dynamically trained, in real-time, as different systems 220 and/or other users 222 are selected for solicitation of responses to these user intents. For example, the entity selection algorithm 226 may simultaneously, and continuously, process extracted intents associated with different users to select different systems 220 and/or other users 222 that may be capable of providing relevant responses to these intents. Further, as the requests corresponding to these intents are presented to these different systems 220 and/or other users 222, any feedback received corresponding to these myriad requests and corresponding intents may be used to dynamically, and in real-time, re-train or otherwise update the entity selection algorithm 226. Thus, as different intents are extracted from corresponding requests in real-time as these requests are received, the entity selection algorithm 226, in real-time, may continuously select different systems 220 and/or other users 222 to which these intents may be provided in order to solicit responses to these intents and may continuously be re-trained or otherwise updated as feedback is received corresponding to the selection of these different systems 220 and/or other users 222. This allows for the entity selection algorithm 226 to constantly process intents associated with different users as these intents are dynamically extracted by the intent processing system 104 through the intent extraction algorithm 224 implemented to dynamically extract intents from exchanged communications in real-time. Further, this allows for the entity selection algorithm 226 to be constantly updated in real-time based on feedback corresponding to the selection of different systems 220 and/or other users 222 and as new intents are constantly being processed by the entity selection algorithm 226.

The output produced by the entity selection algorithm 226 implemented by the intent machine learning modeling engine 212 may include identifiers corresponding to the other systems 220 and/or other users 222 to which the intent is to be provided in order to solicit responses to the request submitted by the user 218 (e.g., the extracted intent) from these other systems 220 and/or other users 222. Based on this output, the intent machine learning modeling engine 212 may transmit the intent to the identified other systems 220 and/or other users 222. For instance, the intent machine learning modeling engine 212 may update a user interface of an intent messaging application of each of the identified other systems 220 (as implemented on computer systems utilized by agents associated with the identified other systems 220) and/or other users 222 to present the intent. The intent may be assigned a unique identifier such that responses from the other systems 220 and/or other users 222 to the intent may be associated with the intent by the unique identifier. A system or other user receiving the intent via the intent messaging application may respond to the intent and submit a response to the intent processing system 204, which may evaluate the response to determine whether the response is relevant to the intent.

In an embodiment, the intent is provided anonymously to the identified other systems 220 and/or other users 222. For instance, the intent machine learning modeling engine 212 may automatically remove any identifying information of the user 218 (e.g., user name, user address, user contact information, etc.) when supplying the intent to the identified other systems 220 and/or other users 222. However, the intent machine learning modeling engine 212 may provide, in addition to the intent, other information that may be useful to the other systems 220 and/or other users 222 in preparing a response to the intent. For instance, the intent may be provided with a general location of the user 218 (e.g., city, state, etc.). This general location can be used to determine whether the other systems 220 and/or other users 222 can provide a response to the intent that may be indicative of an ability to assist the user 218 at the general location (e.g., a particular other system may maintain a point-of-sale location within the general location, a user provides goods and services at the general location, etc.).

In an embodiment, once another system or other user submits a response to the intent, the intent messaging service 202 may disable the other system's or other user's ability to provide additional responses to the intent via their intent messaging application. This prevents other systems 220 or other users 222 from potentially inundating the user 218 with responses to a particular intent. For instance, in an embodiment, the intent processing system 204, in response to obtaining an intent response from a particular other system or other user, transmits one or more executable instructions to the intent messaging application implemented by the other system or other user to disable one or more functions of the intent messaging application that are usable to submit responses to provided requests/intents. These one or more executable instructions may be transmitted to the intent messaging application implemented by the particular other system or other user through one or more APIs. A communications session with the user 218, via the intent messaging application, may be established upon a request from the user 218 to initiate a communications session with a particular other system 220 or other user 222.

In an embodiment, the intent processing system 204, in response to obtaining an intent response from another system or other user, may automatically process the intent response through a response evaluation algorithm 228 to automatically, and in real-time, evaluate the intent response in order to classify the intent response as either being relevant to the intent or irrelevant to the intent. The response evaluation algorithm 228, in an embodiment, is dynamically trained, in real-time, using a dataset of input intents (e.g., historical intents associated with previously submitted requests, hypothetical intents, etc.), known relevant responses (e.g., historical responses deemed relevant by users that submitted associated requests/intents, hypothetical relevant responses for hypothetical intents, etc.), known irrelevant responses (e.g., historical responses rejected by users that submitted associated requests/intents, hypothetical irrelevant responses for the hypothetical intents, etc.), and corresponding classifications (e.g., historical classifications made in response to user feedback to provided responses, historical classifications made by an evaluator of historical responses submitted by other systems and other users, hypothetical classifications corresponding to hypothetical responses, etc.).

In some instances, the response evaluation algorithm 228 used to classify intent responses as being relevant or irrelevant may be dynamically trained in real-time using feedback from users, including user 218. For instance, if a response classified as being relevant to an intent is provided to the user 218, the user 218 may provide feedback indicating whether the response was indeed relevant to the intent. This feedback may be used to either reinforce the response evaluation algorithm 228 (e.g., a response classified as being relevant was deemed relevant to the intent by the user 218) or to update the response evaluation algorithm 228 (e.g., a response classified as being relevant was deemed to be irrelevant to the intent by the user 218). As users associated with the intent messaging service 102 provide their feedback to the intent messaging service 102, the response evaluation algorithm 228 may be dynamically updated in real-time.

Any responses classified as being irrelevant to the intent may be automatically discarded by the response evaluation algorithm 228. Further, any responses that are classified as being relevant to the intent may be provided to the user messaging system 206 by the response evaluation algorithm 228. In response to receiving a relevant response for a particular request/intent, the user messaging system 206 may automatically present this response to the user 218 via the intent messaging application implemented on the user's computing device. Further, the intent response may be provided with options for the user 218 to invite the other system or other user that submitted the intent response to a communications session with regard to the intent, to thank the other system or other user for their intent response, to ignore the intent response from the other system or other user, to ignore future responses from the other system or other user (e.g., block the other system or other user), and the like. If the user 218 opts to establish a communications session with the other system or other user based on the provided intent response, the user messaging system 206 may establish the communications session between the user 218 and the other system or other user to allow for the user 218 and the other system or other user to communicate through their respective intent messaging applications. In an embodiment, the user messaging system 206 provides, to the other system or other user, identifying information associated with the user 218 (e.g., name, images, address, contact information, etc.) upon establishing the communications session between the user 218 and the other system or other user.

In addition to establishing a communications session between the user 218 and the other system or other user, the user messaging system 206 may re-enable the other system or other user to transmit responses and other communications to the user 218 over the newly established communications session. For instance, through the aforementioned APIs, the user messaging system 206 may transmit one or more executable instructions to the intent messaging application implemented on a computing device associated with the other system or other user that, when executed by the intent messaging application, may cause the intent messaging application to enable the other system or other user to communicate with the user 218 through this newly established communications session.

As noted above, any feedback provided by the user 218 with regard to a provided response to their request or intent may be used to dynamically update, in real-time, the response evaluation algorithm 228. For instance, if the user 218 selects an option ignore the intent response from the other system or other user and/or to block the other system or other user from responding to future requests or intents from the user 218, the user messaging system 206 may flag the response provided by this other system or other user as being received negatively by the user 218. This may serve as an indication that the user 218 did not find the provided response to be relevant to their request/intent. The user messaging system 206 may update the dataset used to train the response evaluation algorithm 228 to incorporate this negative feedback as a new datapoint that may be processed by the response evaluation algorithm 228 to dynamically re-train the response evaluation algorithm 228 such that similar responses from the other system/other user and/or from other entities for similar intents are more likely to be classified as being irrelevant to these similar intents. Alternatively, if the user 218 selects an option to establish a new communications session with a particular other system or other user or to thank the other system or other user based on their response to the user's request/intent, the user messaging system 206 may flag the response from the other system or other user as being received positively by the user 218. The user messaging system 206 may update the dataset used to train the response evaluation algorithm 228 to incorporate this positive feedback as a new datapoint that may be processed by the response evaluation algorithm 228 to reinforce the response evaluation algorithm 228 such that similar responses provided by different systems and other users for similar intents are more likely to be classified as being relevant to these similar intents.

In an embodiment, the user messaging system 206 implements a sentiment analysis algorithm that is dynamically trained to process, in real-time, communications exchanged between users and other systems 220/other users 222 to automatically determine user sentiment as these communications are exchanged. The sentiment analysis algorithm may implement NLP or other language processing to dynamically process, in real-time, any communications exchanged between the user 218 and another system 220 or other user 222 as these communications are exchanged to determine the user's sentiment with regard to the communications session. For example, the user messaging system 206, through the sentiment analysis algorithm, may evaluate an exchanged communication to determine whether the exchanged communications includes an anchor. Examples of an anchor may include a string of text associated with a polarity (e.g., sentiment or intent, the word “frustrated” corresponding to a negative polarity or frustrated polarity, the word “happy” corresponding to a positive polarity, and so on). For example, a term “dispute” for one user can be negative but can be neutral or positive for a second user. In some instances, anchors can be dynamically determined using supervised machine learning techniques. For example, one or more clustering algorithms can be executed on stored communications to find patterns within the stored communications. The clustered communications can be further filtered and evaluated to determine the anchor. Further, one or more words near the identified anchor can be parsed for amplifiers. An example of an amplifier is a term that increases or decreases an intensity associated with the polarity of the anchor, such as “really,” “not really,” “kind of,” and so on. The characteristic can include, for example, the speed of typing, the number of special characters used in the message (e.g., exclamation points, question marks, and so on), a semantic analysis of a message (e.g., by identifying keywords, sentence structures, repeated words, punctuation characters and/or non-article words); user input (e.g., having selected one or more categories); and/or message-associated statistics (e.g., response latency).

In an embodiment, the sentiment analysis algorithm can dynamically calculate, in real-time, a parameter corresponding to each communication exchanged during the communications session as the communication is being exchanged. As a non-limiting example of a parameter, the sentiment analysis algorithm may calculate a numerical score that indicates the high intensity of a negative polarity (e.g., a parameter of 20 on a scale of 0-100, with lower numbers indicating a negative polarity and higher numbers indicating a positive polarity). In a further example, if the term “kind of” is near the anchor “don't like” (e.g., as in the sentence “I kind of don't like”), the term “kind of” may be identified as an amplifier term that indicates a medium intensity of the negative polarity. In this case, a parameter can be generated based on the identification of the medium intensity of the negative polarity. As a non-limiting example, the parameter can be a numerical score that indicates the medium intensity of the negative polarity (e.g., a parameter of 40, as opposed to the message parameter of 20).

In an embodiment, the parameter corresponding to each communication can be used to determine the user's sentiment with regard to the communications session between the user 218 and the other system or other user. For example, if the user messaging system 206, through the sentiment analysis algorithm, determines that user 218 has a negative sentiment towards the communications session with the other system or other user, the user messaging system 206 may use this negative sentiment to update the entity selection algorithm 226 such that, for similar requests and intents, the entity selection algorithm 226 is less likely to provide these similar requests and intents to the other system or other user. Further, in some instances, the user messaging system 206 may update the response evaluation algorithm 228 such that responses to the user's request or intent provided by this other system or other user are more likely to be deemed irrelevant to the user's request or intent, resulting in these responses being more likely to be discarded by the response evaluation algorithm 228.

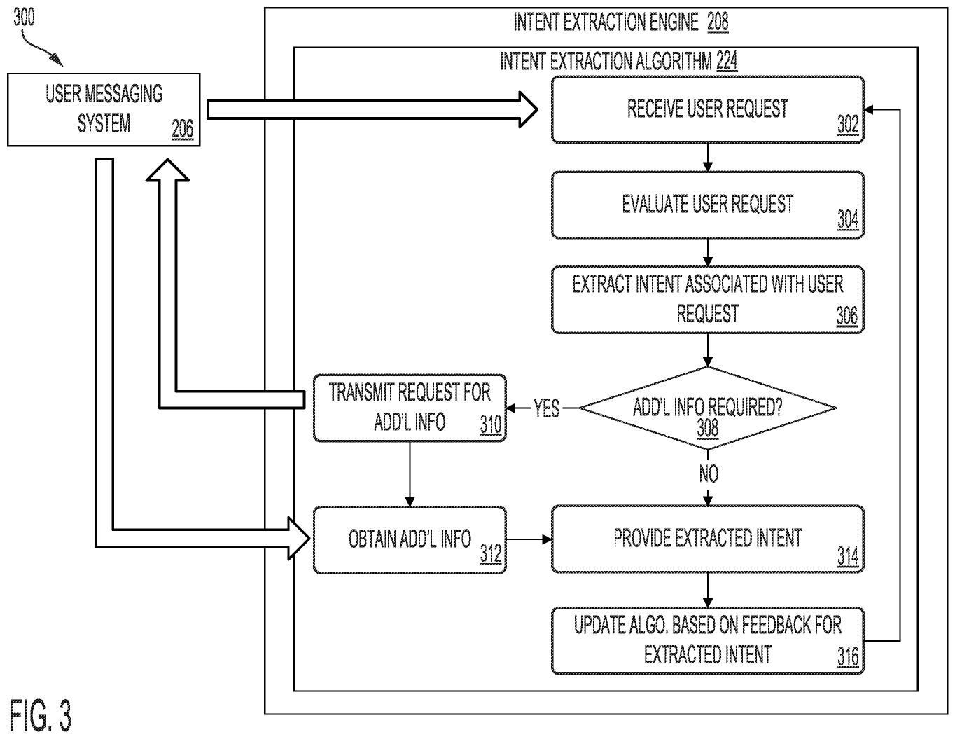

FIG. 3 shows an illustrative example of an environment 300 in which an intent extraction algorithm 224 dynamically, and in real-time, processes an incoming request associated with a user to extract an intent associated with the incoming request in accordance with at least one embodiment. In the environment 300, and as noted above, the intent extraction engine 208 may implement an intent extraction algorithm 224. The intent extraction algorithm 224 may be dynamically trained, in real-time, to process incoming requests from different users to identify the intent expressed in the request. As noted above, the intent extraction algorithm 224 may be dynamically trained, in real-time, to perform a semantic analysis of the request (e.g., by identifying keywords, sentence structures, repeated words, punctuation characters and/or non-article words) to identify the intent expressed in the request. An intent can also be determined, for example, based on user input (e.g., having selected one or more categories); and/or communication-associated statistics (e.g., typing speed and/or response latency).

At step 302, the intent extraction algorithm 224 may automatically receive a user request from the user messaging system 206. For instance, when a user communicates a request to the user messaging system 206 through their intent messaging application to identify one or more other systems and/or other users that may be able to address the user's intent, the user messaging system 206 may automatically, and in real-time, provide this request to the intent extraction algorithm 224 for identification of the user's intent expressed in the request. In an embodiment, the intent extraction algorithm 224 can simultaneously, and continuously, process communications exchanged between different users and the user messaging system 206 to extract any intents expressed by these users. Further, in some instances, the intent extraction algorithm 224 may automatically, and in real-time, monitor any communications between the user and the user messaging system 206 as these communications are exchanged to receive the user request communicated by the user to the user messaging system 206.

At step 304, the intent extraction algorithm 224 may evaluate the user request communicated by the user to the user messaging system 206. As noted above, the intent extraction algorithm 224 is dynamically trained using a dataset of input requests (e.g., historical input requests submitted by different users, hypothetical input requests generated for training of the intent extraction algorithm 224, etc.) and known intents included in the input requests (e.g., historical intents associated with historical input requests, hypothetical intents associated with hypothetical input requests, etc.). Through this dynamic training of the intent extraction algorithm 224, the intent extraction algorithm 224 may automatically, and in real-time, evaluate the obtained user request communicated by the user to the user messaging system 206 to extract the user's intent from the request at step 306.

At step 308, the intent extraction algorithm 224 may determine whether additional information associated with the user is required for the extracted intent. For instance, the intent extraction algorithm 224 may determine, based on the extracted intent, that the user's geographic location and timeframe for resolution of the intent are required. As another illustrative example, if the extracted intent corresponds to the user's desire to obtain a replacement tire for their vehicle, the intent extraction algorithm 224 may dynamically determine that information corresponding to the user's vehicle may be required in order to allow for resolution of this intent (e.g., tire recommendations that correspond to the vehicle's make and model, etc.).

If the intent extraction algorithm 224 determines, based on the extracted intent, that additional information may be needed to supplement the extracted intent, the intent extraction algorithm 224, at step 310, may transmit a request to the user messaging system 206 to solicit this additional information from the user. In response to this request, the user messaging system 206 may use NLP, interactive voice recognition systems, and/or other forms of conversational voice algorithms and/or systems to prompt the user to provide the requested additional information. Responses provided by the user may be provided to intent extraction algorithm 224, which may accordingly obtain the additional information included in these responses at step 312. The intent extraction algorithm 224 may use these responses and the supplied request from the user to supplement the extracted intent with the additional information provided by the user.

At step 314, the intent extraction algorithm 224 may provide the extracted intent (and any additional information provided by the user and used to supplement the extracted intent) to the intent machine learning modeling engine. As noted above, and described in greater detail herein, the intent machine learning modeling engine may identify other systems and/or other users to which an intent may be supplied in order to solicit responses to the intent. Thus, the extracted intent and additional information (if required) may allow the intent machine learning modeling engine to identify the appropriate other systems and/or other users that may be likely to provide relevant responses to the extracted intent.

At step 316, the intent extraction algorithm 224 may be updated, in real-time, based on any obtained feedback corresponding to the extracted intent. As noted above, in some instances, when the intent extraction algorithm 224 extracts an intent from a received request, the intent extraction algorithm 224, through the user messaging system 206, may present the extracted intent to the user. The user may review the extracted intent and provide feedback corresponding to the identification of the user's intent, as expressed in their request to the user messaging system 206. Based on the user's feedback, the intent extraction algorithm 224 may be dynamically updated to improve the accuracy of the intent extraction algorithm 224 in identifying and extracting the appropriate intent from a received user request.

As noted above, the intent extraction algorithm 224 is dynamically trained and updated, in real-time, as intents are extracted from incoming requests associated with different users associated with the intent messaging service. For example, the intent extraction algorithm 224 may simultaneously, and continuously, process communications exchanged between different users and the user messaging system 206 to extract any intents expressed by these users. Further, as these intents are presented to these users, any feedback received corresponding to these myriad intents may be used to dynamically, and in real-time, re-train or otherwise update the intent extraction algorithm 224. Thus, as users continuously communicate with the user messaging system 206 to submit their requests, the intent extraction algorithm 224, in real-time, may continuously extract corresponding intents and may continuously be re-trained or otherwise updated as feedback is received corresponding to these intents. This allows for the intent extraction algorithm 224 to constantly process communications exchanged between different users and the user messaging system 206 as these communications are received and extract corresponding intents expressed by these users. Further, this allows for the intent extraction algorithm 224 to be constantly updated in real-time based on feedback corresponding to these intents and as new communications are constantly being processed by the intent extraction algorithm 224.

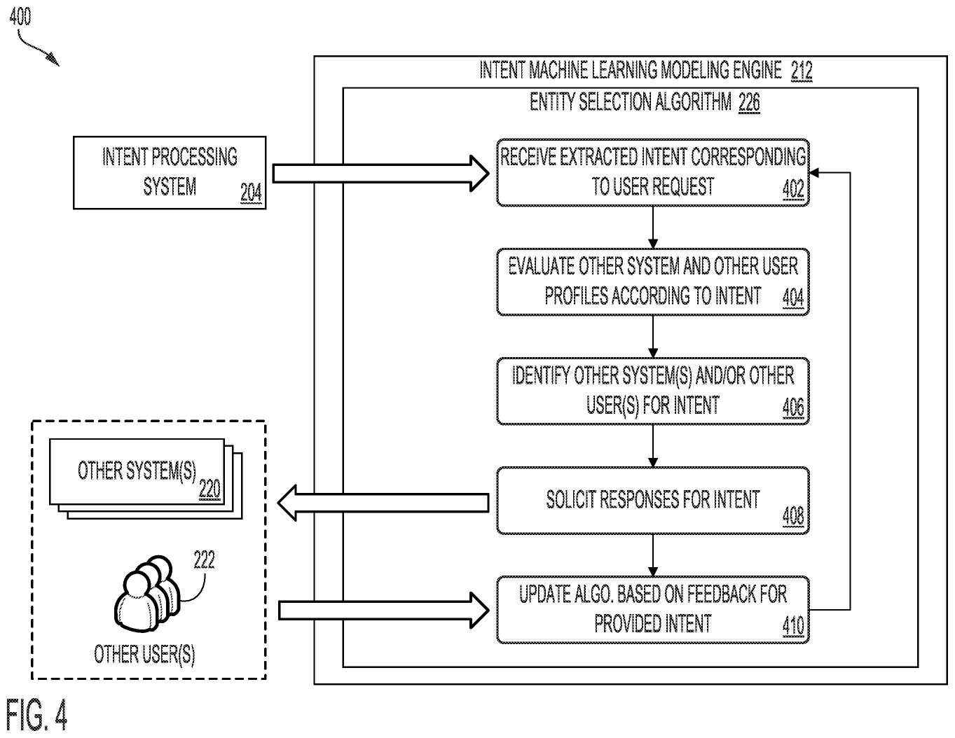

FIG. 4 shows an illustrative example of an environment 400 in which an entity selection algorithm 226 dynamically, and in real-time, selects one or more other systems 220 and other users 222 from which to solicit responses to an intent associated with a user request in accordance with at least one embodiment. In the environment 400, and as noted above, the intent machine learning modeling engine 212 may implement an entity selection algorithm 226 that is dynamically trained, in real-time, to identify and solicit responses from different systems 220 and/or other users 222 according to provided user intents. For instance, the entity selection algorithm 226 may be dynamically trained in real-time using sample intents and corresponding sample outputs that may be used to identify the other systems 220 and other users 222 to which an intent is to be provided in order to solicit responses to the intent from these other systems 220 and other users 222.

At step 402, the entity selection algorithm 226 may receive, in real-time and from an intent processing system 204, an extracted intent corresponding to a user request. As noted above, the intent processing system 204 implements an intent extraction algorithm that is dynamically trained, in real-time, to process incoming user requests to identify and extract the intents expressed by the users in their user requests. The extracted intent may correspond to an issue that the user wishes to have resolved. Examples of intents can include (for example) a topic, a sentiment, a complexity, and an urgency. A topic can include, but is not limited to, a subject, a product, a service, a technical issue, a use question, a complaint, a refund request or a purchase request, and the like.

At step 404, the entity selection algorithm 226 may evaluate any available profiles corresponding to different systems and other users according to the received intent. As noted above, the entity selection algorithm 226 may obtain information corresponding to the other systems 220 and other users 222 from a system database and user database, respectively, maintained by the intent matching system. This information may be included within a profile, which may indicate a user's or other system's experience responding to particular intents or categories of intents, as well as the user's or other system's interest in the underlying topic or classification of the intent. Further, each profile may indicate feedback with regard to a user's or other system's response to previously provided intents. This feedback may specify whether a response provided for a particular intent was relevant, useful, or otherwise appreciated by the user that submitted the request associated with the particular intent.

In some instances, the entity selection algorithm 226 may further evaluate the profile corresponding to the user associated with the intent (e.g., the user that submitted the request from which the intent was extracted) to identify any user preferences for particular other systems 220 or other users 222. For instance, the user's profile may specify which other systems 220 or other users 222 the user has historically interacted with to address previously supplied intents. Further, for each of these interactions, the profile may include feedback from the user. This feedback may indicate whether interaction with a particular other system or other user was relevant to the corresponding intent, useful in addressing the corresponding intent, or otherwise conducive to a positive experience with the other system or other user.

At step 406, based on the evaluation of the profiles associated with the other systems 220 and other users 222, as well as of the profile associated with the user that submitted the intent, the entity selection algorithm 226 may identify one or more other systems and/or other users that may be provided with the intent. As noted above, the entity selection algorithm 226 is dynamically trained in real-time using sample intents and corresponding sample outputs (e.g., historical systems and/or users selected based on the historical intents, historical systems and/or users that have engaged in communications sessions with requesting users according to the historical intents, hypothetical systems and/or users selected based on the hypothetical intents, etc.) that may be used to identify the other systems 220 and other users 222 to which an intent is to be provided in order to solicit responses to the intent from these other systems 220 and other users 222. Thus, based on its evaluation of the intent and of the available profiles corresponding to the myriad other systems 220 and other users 222 associated with the intent messaging service, the entity selection algorithm 226 may automatically select one or more other systems and/or other users from which to solicit responses to the provided intent.

At step 408, the entity selection algorithm may solicit, from the selected one or more other systems and/or other users, responses to the intent provided by the intent processing system 204. As noted above, the entity selection algorithm 226 may provide identifiers corresponding to the other systems 220 and/or other users 222 to which the intent is to be provided in order to solicit responses to the intent expressed by the user from these other systems 220 and/or other users 222. Based on this output, the intent machine learning modeling engine 212 may transmit the intent to the identified other systems 220 and/or other users 222. For instance, the intent machine learning modeling engine 212 may update a user interface of an intent messaging application of each of the identified other systems 220 (as implemented on computer systems utilized by agents associated with the identified other systems 220) and/or other users 222 to present the intent. The intent may be assigned a unique identifier such that responses from the other systems 220 and/or other users 222 to the intent may be associated with the intent by the unique identifier. A system or other user receiving the intent via the intent messaging application may respond to the intent and submit a response to the intent processing system 204, as described above.

At step 410, the entity selection algorithm 226 may be updated in real-time based on feedback provided by other systems 220 and/or other users 222 with regard to the solicitation of responses for the provided intent. This feedback may be used to determine whether the entity selection algorithm 226 is accurately selecting other systems 220 and other users 222 that are likely to provide, for the extracted intent, a relevant response or that are otherwise associated with a feature of the extracted intent. Returning to an earlier illustrative example, if another system that provides interior design services obtained an intent that is not related to interior design, the other system may provide feedback indicating that the provided intent is not relevant to the other system. As another illustrative example, if another system that provides automotive services obtained an intent corresponding to a request for tire recommendations corresponding to a particular vehicle, the other system may provide feedback in form of a relevant response to the intent, as determined by the intent processing system 204. This feedback may be used to further train the entity selection algorithm 226 implemented by the intent machine learning modeling engine 212.

As noted above, the entity selection algorithm 226 is dynamically trained and updated, in real-time, as different systems 220 and/or other users 222 are selected for solicitation of responses to different user intents. For example, the entity selection algorithm 226 may simultaneously, and continuously, process extracted intents associated with different users to select different systems 220 and/or other users 222 that may be capable of providing relevant responses to these intents. Further, as the requests corresponding to these intents are presented to these different systems 220 and/or other users 222, any feedback received corresponding to these myriad requests and corresponding intents may be used to dynamically, and in real-time, re-train or otherwise update the entity selection algorithm 226. Thus, as different intents are extracted from corresponding requests in real-time as these requests are received, the entity selection algorithm 226, in real-time, may continuously select different systems 220 and/or other users 222 to which these intents may be provided in order to solicit responses to these intents and may continuously be re-trained or otherwise updated as feedback is received corresponding to the selection of these different systems 220 and/or other users 222. This allows for the entity selection algorithm 226 to constantly process intents associated with different users as these intents are dynamically extracted by the intent processing system 204 through the aforementioned intent extraction algorithm 224 described above in connection with FIGS. 2-3 and implemented to dynamically extract intents from exchanged communications in real-time. Further, this allows for the entity selection algorithm 226 to be constantly updated in real-time based on feedback corresponding to the selection of different systems 112 and/or other users 114 and as new intents are constantly being processed by the entity selection algorithm 226.

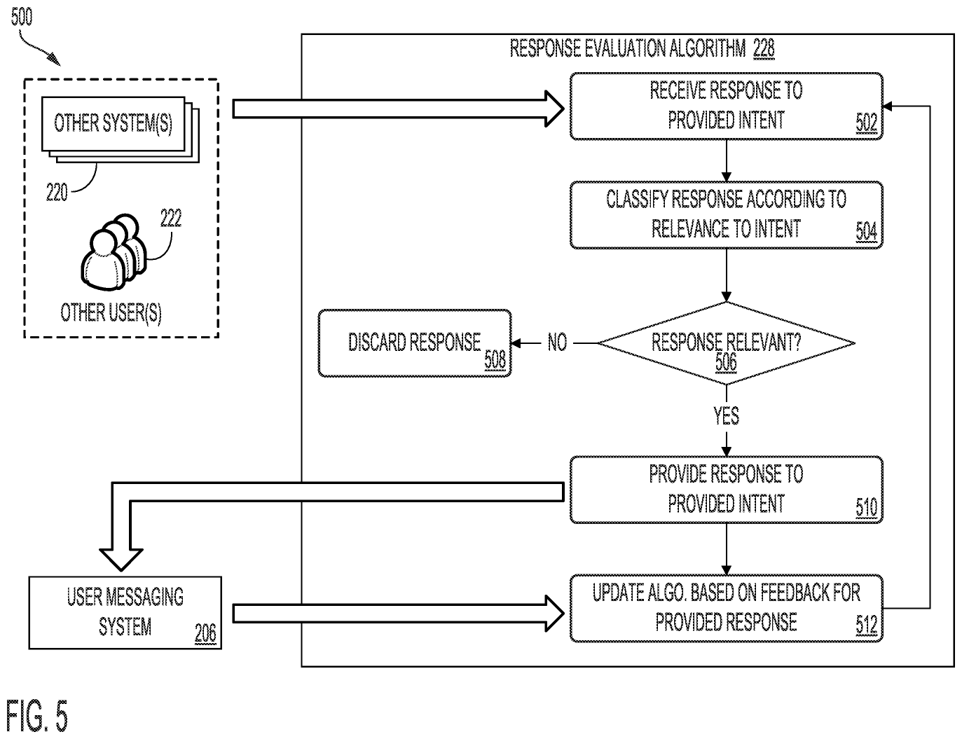

FIG. 5 shows an illustrative example of an environment 500 in which a response evaluation algorithm 228 dynamically, and in real-time, evaluates responses from other systems 220 and/or other users 222 for a particular intent to automatically provide relevant responses for the particular intent in accordance with at least one embodiment. In the environment 500, and as noted above, the intent processing system may implement a response evaluation algorithm 228 that is dynamically trained, in real-time, to evaluate intent responses from different systems 220 and other users 222 according to the provided intent in order to classify these intent responses as either being relevant to the intent or irrelevant to the intent. For instance, the response evaluation algorithm 228 may be dynamically trained, in real-time, using a dataset of input intents, known relevant responses, known irrelevant responses, and corresponding classifications for these responses.

At step 502, the response evaluation algorithm 228 may receive a response to an intent provided to one or more other systems 220 and/or other users 222. As noted above, a response to a particular intent may be provided with an identifier corresponding to the particular intent. The response evaluation algorithm 228 may use this identifier to automatically identify the intent corresponding to the received response. Further, using this identifier, the response evaluation algorithm 228 may retrieve information corresponding to the user that submitted the request associated with the particular intent. As described in greater detail herein, this supplemental information may be used by the response evaluation algorithm 228 to automatically, and in real-time, determine the relevance of the received response.

In an embodiment, when the response evaluation algorithm 228 receives a response from a particular system 220 or other user 222 for an intent, the response evaluation algorithm 228 may automatically, and in real-time, prohibit this particular system 220 or other user 222 from submitting additional responses for the intent. For instance, in response to obtaining an intent response from a particular other system or other user, the response evaluation algorithm 228 may automatically transmit one or more executable instructions to the intent messaging application implemented by the other system or other user to disable one or more functions of the intent messaging application that are usable to submit responses to provided requests/intents. These one or more executable instructions may be transmitted to the intent messaging application implemented by the particular other system or other user through one or more APIs. This may prevent the other system or other user from potentially inundating the user that submitted the request corresponding to the intent with responses to a particular intent.

At step 504, the response evaluation algorithm 228 may classify the received response according to the relevance of the response to the particular intent. For instance, if the provided intent corresponds to an automotive issue that the user would like to have resolved or otherwise obtain guidance with regard to having the automotive issue resolved, the response evaluation algorithm 228 may, in real-time, process the received response to determine whether this response includes one or more elements corresponding to the automotive issue. For example, the response evaluation algorithm 228 may perform a semantic analysis of the received response to determine whether the response includes one or more anchors corresponding to the automotive issue. For instance, the response evaluation algorithm 228 may determine whether the provided response includes the anchor terms or phrases “automotive,” “vehicle,” “car,” “tires,” “engine,” and other similar terms that are commonly associated with an automotive issue. If the response does not include any of these known anchor terms or phrases, or alternatively includes one or more anchor terms or phrases that are wholly related to automotive issues (e.g., “boat,” “baby,” “supermarket,” etc.), the response evaluation algorithm 228 may determine that the response is irrelevant to the intent. In some instances, if the user, in their request, indicated the make and model of their vehicle, the response evaluation algorithm 228 may determine whether the response includes any anchor terms corresponding to the make and model of the user's vehicle. If the response includes one or more anchor terms corresponding to vehicles having a different make and model than the user's vehicle and does not make reference to the user's vehicle, the response evaluation algorithm 228 may deem such a response to be irrelevant to the intent.

Based on the evaluation and corresponding classification of the received response, the response evaluation algorithm 228, at step 506, may determine whether the received response is relevant to the intent. If the response evaluation algorithm 228 determines that the received response is not relevant to the intent, the response evaluation algorithm 228, at step 508, may automatically discard the response without providing the response to the user messaging system 206. Additionally, in an embodiment, if the response evaluation algorithm 228 determines that another system 220 or other user 222 has provided an irrelevant response to an intent, the response evaluation algorithm 228 automatically updates the profile of the other system 220 or other user 222 to indicate that the other system 220 or other user 222 has provided an irrelevant response to the intent. This may reduce the likelihood of the other system 220 or other user 222 from being selected by the intent matching system to provide a response to similar intents. In some instances, this feedback may also be used to dynamically train the entity selection algorithm implemented by the intent matching system to further reduce the likelihood of the other system 220 or other user 222 being solicited to provide responses to similar intents. If the other system 220 or other user 222 is deemed to be providing irrelevant responses on a consistent basis (e.g., at a rate that surpasses a threshold frequency, etc.), other remedial operations may be performed, such as suspending, disassociating, or removing the other system 220 or other user 222 from the intent messaging service.

If the response evaluation algorithm 228 determines that the received response is relevant to the intent, the response evaluation algorithm 228, at step 510, may provide the response to the user messaging system 206. In response to receiving the response, the user messaging system 206 may automatically present this response to the user via the intent messaging application implemented on the user's computing device. Further, the intent response may be provided with options for the user to invite the other system or other user that submitted the intent response to a communications session with regard to the intent, to thank the other system or other user for their intent response, to ignore the intent response from the other system or other user, to ignore future responses from the other system or other user (e.g., block the other system or other user), and the like. As noted above, if the user opts to establish a communications session with the other system or other user based on the provided intent response, the user messaging system 206 may establish the communications session between the user and the other system or other user to allow for the user and the other system or other user to communicate through their respective intent messaging applications.

At step 512, the response evaluation algorithm 228 may be automatically updated, in real-time, based on feedback corresponding to the response provided to the user messaging system 206 and presented to the user that submitted the request/intent. As noted above, if the user selects an option to ignore the intent response from the other system or other user and/or to block the other system or other user from responding to future requests or intents from the user, the user messaging system 206 may flag the response provided by this other system or other user as being received negatively by the user. The user messaging system 206 may update the dataset used to train the response evaluation algorithm 228 to incorporate this negative feedback as a new datapoint that may be processed by the response evaluation algorithm 228 to dynamically re-train the response evaluation algorithm 228 such that similar responses from the other system/other user and/or from other entities for similar intents are more likely to be classified as being irrelevant to these similar intents. Alternatively, if the user selects an option to establish a new communications session with a particular other system or other user or to thank the other system or other user based on their response to the user's request/intent, the user messaging system 206 may flag the response from the other system or other user as being received positively by the user. The user messaging system 206 may update the dataset used to train the response evaluation algorithm 228 to incorporate this positive feedback as a new datapoint that may be processed by the response evaluation algorithm 228 to reinforce the response evaluation algorithm 228 such that similar responses provided by different systems and other users for similar intents are more likely to be classified as being relevant to these similar intents.

It should be noted that while the process described in FIG. 5 is described as being performed for an individual response associated with another system 220 or another user 222, the response evaluation algorithm 228 can automatically process any responses to different intents in real-time and as these responses are received from myriad other systems 220 and other users 222. This allows the response evaluation algorithm 228 to process, in real-time, multiple responses simultaneously from different systems 220 and other users 222 and corresponding to any number of different intents as these responses are received. As a result, the response evaluation algorithm 228 may continuously, and in real-time, determine the relevance of received responses to different intents and provide any relevant responses to different intents to their corresponding users through the user messaging system 206. This allows for the response evaluation algorithm 228 to constantly process responses to different responses from different systems 220 and other users 222 as these responses are received to determine the relevance of these responses to corresponding intents. Further, this allows the response evaluation algorithm 228 to be constantly updated in real-time based on feedback corresponding to the relevancy of any provided responses and as new responses are constantly being processed by the response evaluation algorithm 228.

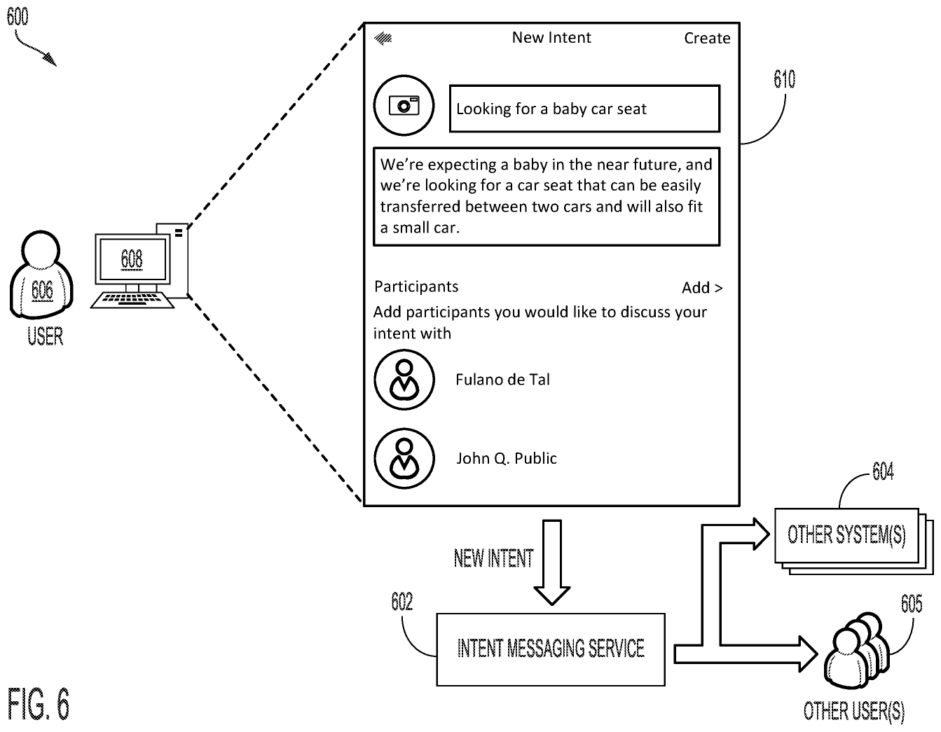

FIG. 6 shows an illustrative example of an environment 600 in which a user 606, via a user interface 610 associated with an intent messaging application implemented on the user's computing device 608, generates an intent to solicit a response from other systems 604 and other users 605 associated with an intent messaging service 602 in accordance with at least one embodiment. In the environment 600, a user 606, via an intent messaging application implemented on a computing device 608, generates a new intent that can be submitted to an intent messaging service 602 to solicit one or more responses from different systems 604 and other users 605 associated with the intent messaging service 602. For instance, using the intent messaging application via the user interface 610, the user 606 may define a request or intent for which the user 606 is seeking responses from different systems 604 and other users 605 associated with the intent messaging service 602.

As illustrated in FIG. 6, the user 606, via the user interface 610, may be presented with an option to provide a title for its request or intent, as well as an option to define the request or intent. For example, the user 606 may provide, as a title to their request or intent, “Looking for a baby car seat” for a request or intent that serves as a solicitation from the user 606 for recommendations for different baby car seats that may be of use to the user 606. Further, via the user interface 610, the user 606 may define the parameters of the request or intent (e.g., “can be easily transferred between two cars,” “fit a small car,” etc.). This information may be utilized by the intent messaging service 602 to extract the intent of the user 606 and identify one or more different systems 604 and other users 605 from which to solicit responses to the intent submitted by the user 606.

As noted above, the intent messaging service 602 may implement an intent extraction algorithm that is dynamically trained, in real-time, to extract intents from submitted requests. Additionally, based on the extracted intent and any other information submitted by the user 606 through the intent messaging application, the intent extraction algorithm may determine whether additional information is required to supplement the extracted intent. Returning to the illustrative example provided in FIG. 6, the intent extraction algorithm may determine that the user 606 is to be prompted with regard to the two cars that the baby car seat is to be transferred between (e.g., make and model of the two cars, etc.). Additionally, or alternatively, the intent extraction algorithm may automatically determine that the user 606 is to be prompted with regard to the small car (e.g., make and model of the small car, etc.) indicated in their request, given that the user 606 has expressed as a requirement that the car seat is to fit into a small car.

In an embodiment, the intent messaging service 602 can utilize NLP, interactive voice recognition systems, and/or other forms of conversational voice algorithms and systems to query the user 606 for additional information (as indicated by the intent extraction algorithm) that can be used to supplement the intent and allow for a tailored identification of different systems 604 and other users 605 that may be likely to provide relevant responses to the intent. For instance, the intent messaging service 602 may query the user 606 to identify a location of the customer, whether other users can help the user 606 with their intent, what the timeframe is for resolution of the intent, and the like. Responses provided by the user 606 to the intent messaging service 602 may be used to further narrow selection of other systems 604 and other users 605 from which responses to the intent may be solicited. For instance, if the user 606 indicates that they are located in Teaneck, N.J. and that they would like to purchase a car seat locally, the intent messaging service 602 may automatically eliminate any other systems or other users that are not in proximity to Teaneck, N.J. (e.g., are outside of a pre-defined geographic radius from Teaneck, N.J., etc.).

In an embodiment, the user 606 can be presented, via the user interface 610, with a listing of contacts or other participants that may be added to the communications session with regard to the submitted intent. For instance, the intent messaging application may automatically obtain a listing of contacts from the user's computing device 608, which may be presented via the user interface 610. Alternatively, the intent messaging application may obtain, from the intent messaging service 602, a listing of contacts associated with the user 606 that also be associated with the intent messaging service 602. This listing of contacts from the intent messaging service 602 may include users that the user 606 has designated as “friends” or otherwise able to directly communicate with the user 606 via communications sessions associated with the intent messaging service 602.

In an embodiment, via the user interface 610, the intent messaging service 602 can further provide recommendations for other systems 604 and/or other users 605 from which the user 606 can solicit a response to the submitted intent. For instance, based on an evaluation of the intent by the intent extraction algorithm and on an evaluation of different profiles corresponding to other systems 604 and other users 605 by the entity selection algorithm implemented by intent messaging service 602, the intent messaging service 602 may recommend one or more other systems 604 or other users 605 that may be likely to provide relevant responses to the submitted intent. The intent messaging service 602 may present these one or more other systems 604 or other users 605 through the user interface 610 to allow the user 606 to select which other systems 604 or other users 605 are to be solicited for a response to the user's intent. Based on the user's selection, the intent messaging service 602 may solicit a response to the intent from the selected other systems and/or other users.

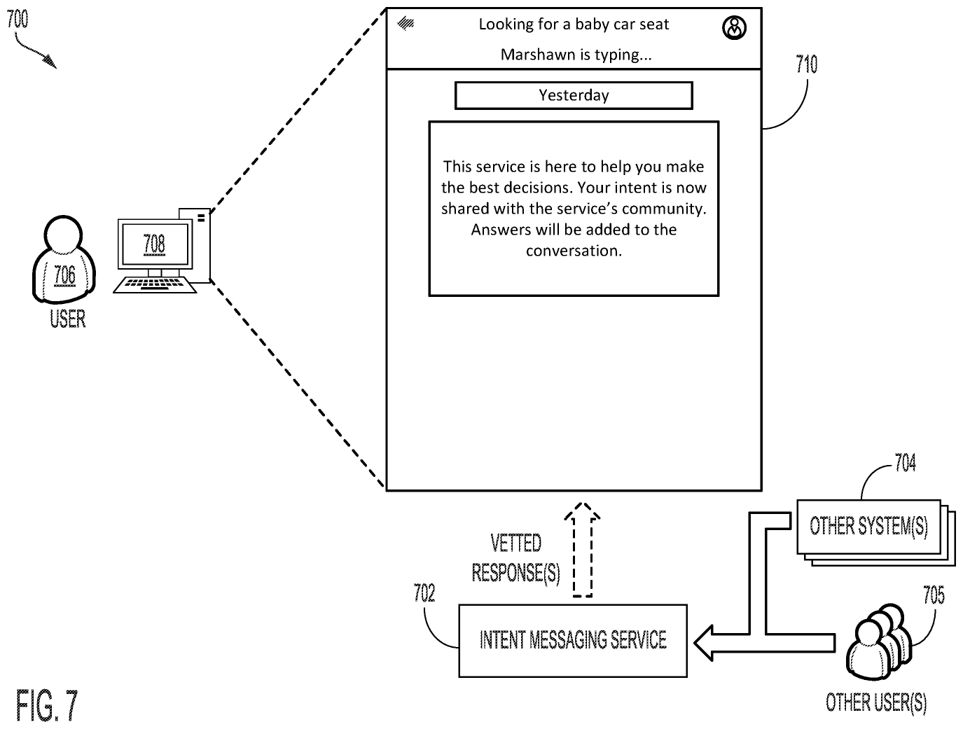

FIG. 7 shows an illustrative example of an environment 700 in which a user 706 is provided with a status with regard to an intent submitted by the user 706 via a user interface 710 in accordance with at least one embodiment. In the environment 700, in response to submitting a new intent to the intent messaging service 702 for solicitation of responses to the intent from one or more other systems 704 and other users 705, the intent messaging service 702 may evaluate the intent and profiles associated with different systems and users associated with the intent messaging service 702 to identify a subset of other systems 704 and other users 705 that may be solicited to provide a response to the intent. Each profile may indicate a user's or other system's experience responding to particular intents or categories of intents, as well as the user's or other system's interest in the underlying topic or classification of the intent. Further, each profile may indicate feedback with regard to a user's or other system's response to previously provided intents. This feedback may specify whether a response provided in response to an intent was relevant, useful, or otherwise appreciated by the corresponding user.

As noted above, the intent messaging service 702 may implement an entity selection algorithm that is dynamically trained, in real-time, identify different systems and/or other users that may be solicited for responses to different intents based on an evaluation of these intents and of profiles associated with these different systems and other users. The entity selection algorithm may automatically, and in real-time, process the intent extracted from the user's request and any available profiles corresponding to different systems and other users to identify the one or more other systems 704 and/or other users 705 that may be solicited for a response to the intent. These one or more other systems 704 and/or other users 705 may be selected according to a likelihood that these one or more other systems 704 and/or other users 705 may provide relevant responses to the intent submitted by the user 706.

In response to obtaining an intent associated with the user 706, the intent messaging service 702 may update the user interface 710 to provide a new communications session window for the provided intent. The name or title of the communications session window presented via the user interface 710 may correspond to the name or title of the request submitted by the user 706 to the intent messaging service 702 via the user interface 710. Further, via the user interface 710 and within the communications session window for the intent, the intent messaging service 702 may provide a status with regard to the processing of the user's provided intent. For instance, as illustrated in FIG. 7, the intent messaging service 702 may indicate that the intent has been shared with the intent messaging service's community (e.g., other systems 704 and other users 705 solicited to provide a response to the intent). Further, the intent messaging service 702 may indicate, via the user interface 710, that any vetted responses from the other systems 704 and/or other users 705 may be presented to the user 706 within the communications session window related to the intent submitted by the user 706.

In an embodiment, the user 706 can introduce one or more other contacts to the communications session associated with the intent and presented through the communications session window in order to enable communications between the user 706 and these one or more contacts through the communications session. For instance, the user 706 may select, from a listing of available contacts, one or more contacts that the user 706 may invite to partake in the communications session associated with the submitted intent. This listing of available contacts may be maintained by the intent messaging service 702 and may be provided to the user 706 through the intent messaging application implemented and executed on computing device 708. Alternatively, the listing of available contacts may be maintained locally on the computing device 708. If the user 706 selects one or more contacts from this listing, the intent messaging service 702 may obtain contact information associated with each of these one or more contacts and transmit a notification to each of these one or more contacts to invite these one or more contacts to partake in the communications session with the user 706 with regard to the intent. If the listing of contacts is maintained locally on the computing device 708, the intent messaging application may obtain the contact information from the computing device 708 and provide this contact information to the intent messaging service 702. The intent messaging service 702 may provide a notification to these contacts with regard to the communications session. In an embodiment, the notification can include a Uniform Resource Identifier (URI) or other network address associated with the communications session. A contact may access the communications session by utilizing the URI or other network address provided by the intent messaging service 702.

As responses to the intent are obtained from the other systems 704 and other users 705 solicited to provide a response to the intent, the intent messaging service 702 may evaluate, in real-time, these responses to determine whether the responses are relevant and responsive to the intent submitted by the user 706. As noted above, the intent messaging service 702 implements a response evaluation algorithm that is dynamically trained, in real-time, to evaluate and classify any received responses to different intents as being either relevant or irrelevant to these different intents. Any responses classified by the response evaluation algorithm as being irrelevant to the intent are automatically discarded by the intent messaging service 702 and may not be presented to the user 706 via the user interface 710. However, any responses classified by the response evaluation algorithm as being relevant to the intent submitted by the user 706 may be presented to the user 706 via the user interface 710. For instance, the intent messaging service 702 may transmit the relevant (e.g., vetted) responses to the intent messaging application on the user's computing device 708 to cause the intent messaging application to update the communications session window associated with the intent to present the obtained relevant responses. The user 706 may select any of the obtained responses to the intent to initiate a communications session with the other system 704 or other user 705 that supplied the selected response. This communications session may be presented within the communications session window, through which the user 706 may communicate with the other system 704 or other user 705.

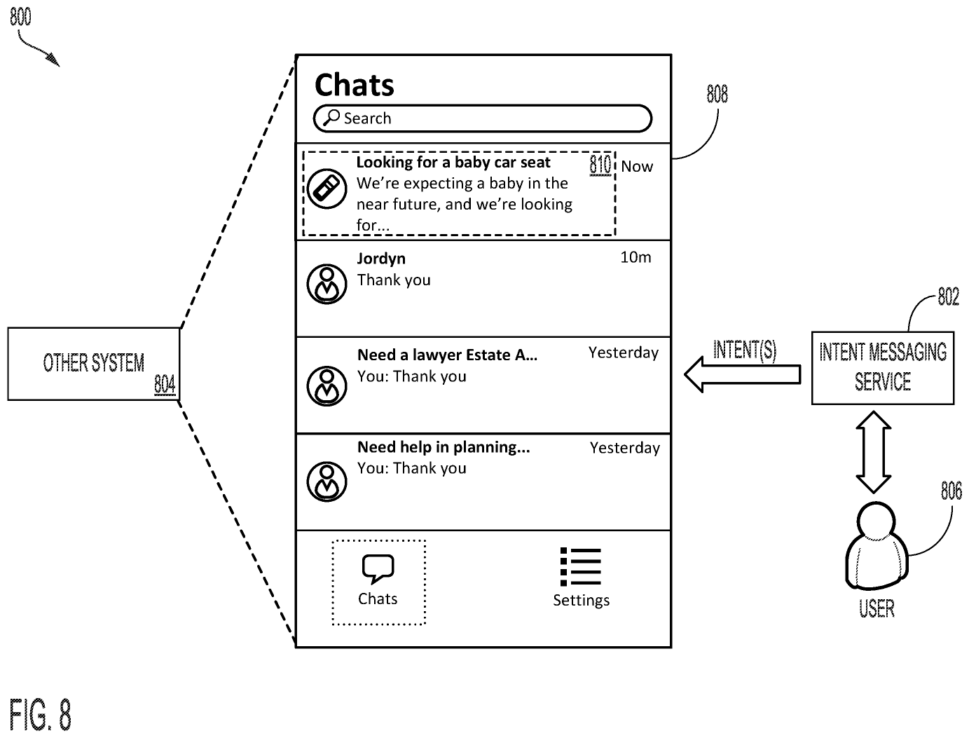

FIG. 8 shows an illustrative example of an environment 800 in which another system 804 is provided with a new intent associated with a user 806 via a user interface 808 of an intent messaging application utilized by the other system 804 to access various user intents in accordance with at least one embodiment. In the environment 800, a user associated with another system 804, via a user interface 808 provided by an intent messaging application, is presented with different intents provided by the intent messaging service 802 via a communications sessions window. Each intent submitted to the intent messaging application may be presented within the user interface 808 through a unique intent panel, such as intent panel 810. When a new intent is obtained by the intent messaging application, the intent may be presented within an intent panel without any identifying information of the user 806 that submitted the intent. For example, as illustrated in FIG. 8, the intent presented in intent panel 810 may be devoid of the user's name, the user's profile picture or image, the user's contact information, and any other identifying information of the user 806. Rather, the intent panel 810 may provide the topic or subject of the intent and a description of the intent as submitted by the user 806.

If the user associated with the other system 804 selects the intent panel 810 from the user interface 808, the intent messaging application may update the user interface 808 to present a communications session window corresponding to the selected intent. Through this communications session window, the user associated with the other system 804 may view the intent and generate an intent response that can be provided to the intent messaging service 802 for evaluation and presentation to the user 806.

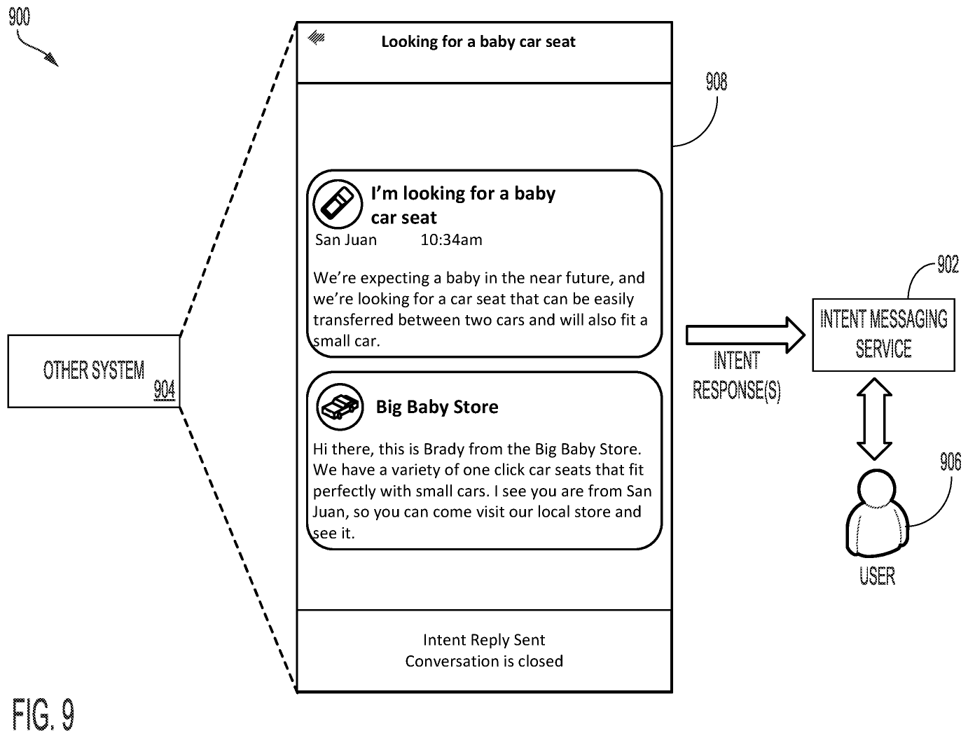

FIG. 9 shows an illustrative example of an environment 900 in which another system 904, via a user interface 908 associated with an intent messaging application utilized by the other system 904, provides a response to an intent associated with a user 906 in accordance with at least one embodiment. In the environment 900, a user associated with another system 904, via a user interface 908 provided by an intent messaging application, can access a communications session window through which the user may evaluate an intent submitted by a user 906 via the intent messaging service 902. For instance, from a communications sessions window presented by the intent messaging application via the user interface 908, the user associated with the other system 904 may select an intent provided to the user by the intent messaging service 902. In response to user selection of the intent, the intent messaging application may update the user interface 908 to present a communications session window that is specific to the selected intent. Through this communications session window, the intent messaging application may present, to the user via the user interface 908, the intent submitted by the user 906.

As noted above, an intent provided to another system or other user is modified to remove any identifying information associated with the user 906 that submitted the intent. For instance, the intent messaging service 902 may remove, from an intent, the user's name, the user's contact information, the user's addresses (e.g., physical mailing address, electronic mail address, etc.), the user's images or pictures, and the like. This may prevent the other system 904 or other user from sending unsolicited messages or responses to the user 906 outside of the context of the intent. The intent messaging service 902, additionally, may supplement the intent with any of the information obtained by the intent messaging service 902 from the user 906 that may be useful to the other system 904. This additional information may include a timeframe for resolution of the intent, a general (as opposed to specific, such as an address) geographic location of the user 906 (e.g., city and state, etc.), a budget for resolution of the intent, and the like.

Through the communications session window presented via the user interface 908, the intent messaging application may provide the intent submitted by the user 906 without the identifying information of the user 906. For instance, rather than providing a user's name and profile picture, the intent messaging application may provide, in the communications session window, the topic of the intent (e.g., “I'm looking for a baby car seat”) and a generic image that may be related to the intent (e.g., a picture of a car, etc.). Further, through the communications session window, the intent messaging application may provide other information that may be useful to the user associated with the other system 904 in responding to the intent. For example, as illustrated in FIG. 9, the intent is presented with a general geographic location of where the intent originated (e.g., “San Juan”) and a time at which the intent was submitted (e.g., “10:34 am”).

In an embodiment, the intent messaging application enables the user associated with the other system 904 to submit a single response to the intent, after which the intent messaging application automatically disables the communications session window to prevent the user from submitting additional responses to the intent. For example, as illustrated in FIG. 9, once the user has submitted a response to the intent (which may be presented in the communications session window), the intent messaging application removes any interface elements that would otherwise allow the user to input a response to the intent presented through the communications session window. The intent messaging application may replace these elements with an indication that the conversation between the user associated with the other system 904 and the user 906 is now closed.

In an embodiment, the intent messaging service 902, in response to obtaining an intent response from the user associated with the other system 904, transmits one or more executable instructions to the intent messaging application implemented by the other system 904 to disable the one or more functions of the intent messaging application that are usable to submit responses to the provided intent. These one or more executable instructions may be transmitted to the intent messaging application through one or more APIs.

In response to obtaining a response to the intent from the user associated with the other system 904, the intent messaging application may transmit the response to the intent messaging service 902 for evaluation and delivery to the user 906. The intent messaging service 902 may evaluate the response from the user associated with the other system 904 to determine whether the response is relevant and responsive to the intent submitted by the user 906. As noted above, the intent messaging service 902 implements a response evaluation algorithm that is dynamically trained, in real-time, to evaluate obtained responses to different intents and accordingly classify these responses as either being relevant or irrelevant to these different intents. If the response is classified as being irrelevant to the intent, the intent messaging service 902 may automatically discard the intent. However, if the response is classified as being relevant to the intent, the intent messaging service 902 may transmit the response to the intent messaging application utilized by the user 906 to present the response to the user 906. For instance, the intent messaging service 902 may transmit the relevant (e.g., vetted) response to the intent messaging application on the user's computing device to cause the intent messaging application utilized by the user 906 to update the communications session window associated with the intent to present the obtained response.

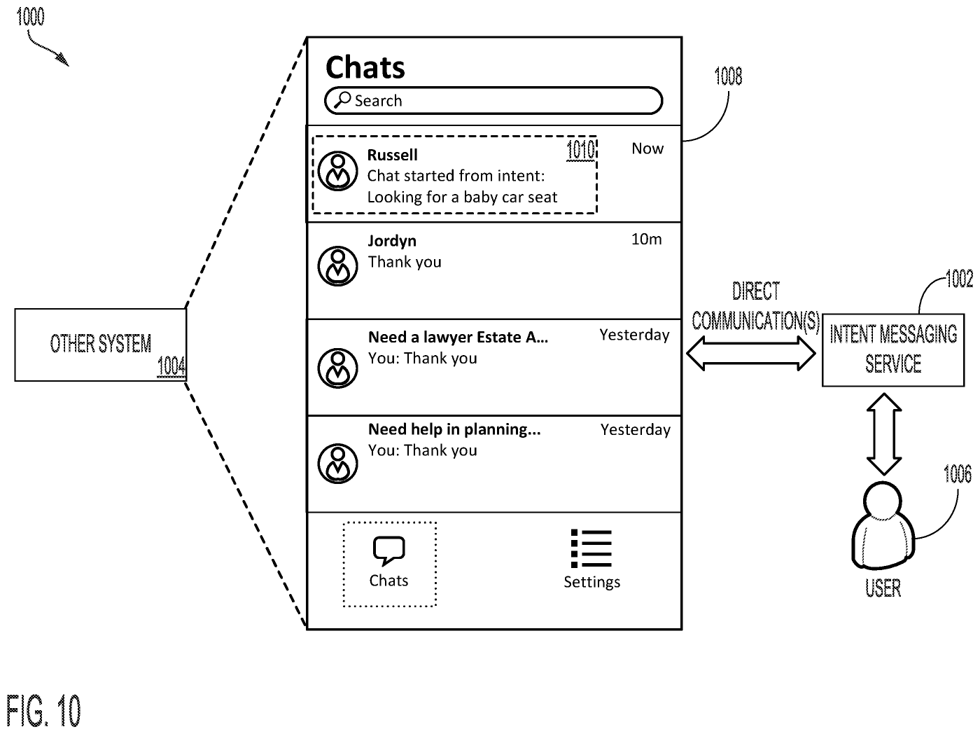

FIG. 10 shows an illustrative example of an environment 1000 in which another system 1004 is authorized to communicate directly with a user 1006 as a result of the user 1006 requesting establishment of a communications session between the user 1006 and the other system 1004 in accordance with at least one embodiment. In the environment 1000, the intent messaging service 1002 may provide, via a user interface 1008 associated with an intent messaging application implemented on a computing device utilized by a user associated with another system 1004, an indication to the user associated with the other system 1004 that the user 1006 has opted to establish a communications session with the user associated with the other system 1004. As noted above, the intent messaging application utilized by the user associated with the other system 1004 may present, via a user interface 1008, a communications sessions window through which a user may interact with different intents submitted to the user by the intent messaging service 1002 or engage in active communications sessions with other users associated with the intent messaging service 1002.

Each intent submitted to the intent messaging application may be presented within the user interface 1008 using a unique intent panel, such as intent panel 1010. When a new intent is obtained by the intent messaging application, the intent may be presented within an intent panel without any identifying information of the user 1006 that submitted the intent. Selection of an intent panel may cause the intent messaging application to update the user interface 1008 to present a communications session window corresponding to the selected intent. Through this communications session window, the user associated with the other system 1004 may view the intent and generate an intent response that can be provided to the intent messaging service 1002 for evaluation and presentation to the user 1006.

In an embodiment, if the user 1006 submits a request to the intent messaging service 1002 to establish a communications session between the user 1006 and the user associated with the other system 1004, the intent messaging service 1002 transmits executable instructions to the intent messaging application utilized by the user associated with the other system 1004 that, when executed by the intent messaging application, cause the intent messaging application to indicate that the user may now interact with the user 1006 with regard to the intent. In addition to these executable instructions, the intent messaging service 1002 may transmit identifying information associated with the user 1006, such as the user's name, the user's contact information (e.g., electronic mail address, physical address, telephone number, etc.), any images or pictures of the user 1006 (e.g., user profile picture, etc.), and the like. In response to receiving these executable instructions and the identifying information associated with the user 1006, the intent messaging application utilized by the user associated with the other system 1004 may update the intent panel 1010 corresponding to the intent submitted by the user 1006 to provide the identifying information associated with the user 1006. For example, as illustrated in FIG. 10, the intent panel 1010 is updated such that a generic image associated with the intent and the title of the intent is replaced with the user's name and profile picture. Further, the intent messaging application may update the intent panel 1010 to indicate that a communications session between the user 1006 and the other system 1004 has been initiated by the user 1006 with regard to the intent (e.g., “Chat started from intent”). The user associated with the other system 1004 may select the intent panel 1010 to access the communications session window associated with the intent and interact with the user 1006 through the newly established communications session.

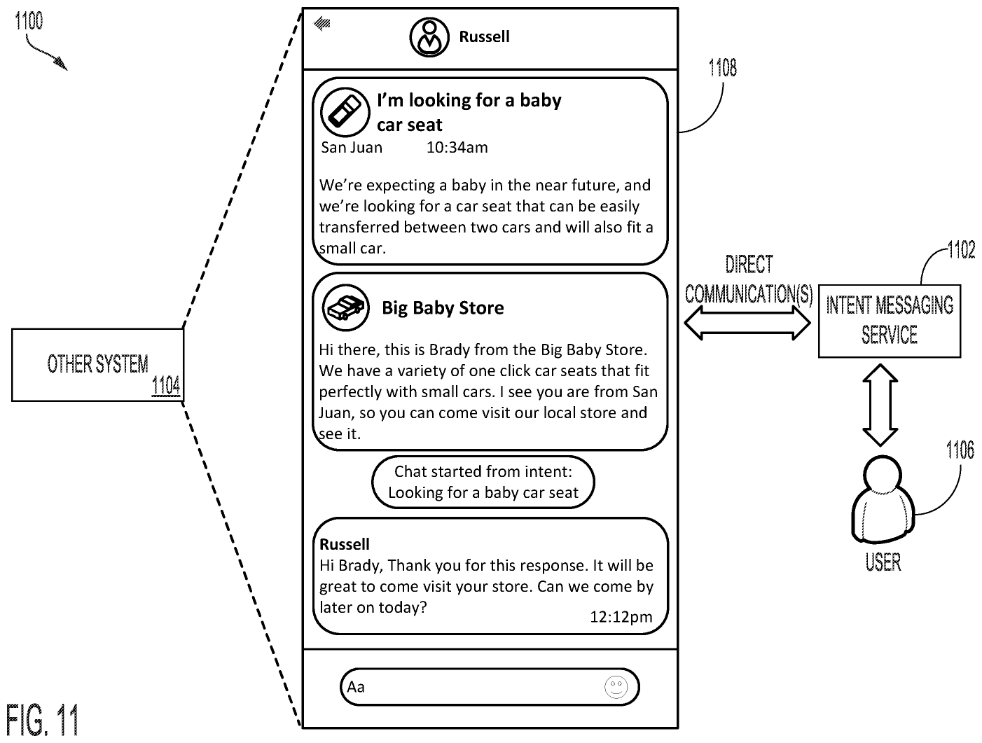

FIG. 11 shows an illustrative example of an environment 1100 in which a communications session between another system 1104 and a user 1106 is established by the intent messaging service 1102 to enable direct communication between the other system 1104 and the user 1106 via an intent messaging application in accordance with at least one embodiment. In the environment 1100, the intent messaging service 1102 may provide, via a user interface 1108 of an intent messaging application executed on a computing device utilized by a user associated with another system 1104, with the ability to interact with a user 1106 with regard to a particular intent. For instance, if a user 1106 indicates that they would like to communicate with a user associated with the other system 1104 based on the intent response submitted by this user, the intent messaging service 1102 may transmit executable instructions to the intent messaging application to allow the user associated with the other system 1104 to interact with the user 1106 through this communications session. For instance, through the aforementioned APIs, the intent messaging service 1102 may transmit one or more executable instructions to the intent messaging application implemented on a computing device associated with the other system 1104 that, when executed by the intent messaging application, may cause the intent messaging application to enable the user associated with the other system 1104 to communicate with the user 1106 through this newly established communications session.

In an embodiment, if the user 1106 indicates that they want to communicate with the user associated with the other system 1104 via the intent messaging service 1102, the intent messaging service 1102 provides additional information associated with the user 1106 to the intent messaging application utilized by the user associated with the other system 1104. For instance, the intent messaging service 1102 may transmit, to the intent messaging application utilized by the user associated with the other system 1104, the user's name, the user's contact information (e.g., electronic mail address, physical address, telephone number, etc.), any images or pictures of the user 1106 (e.g., user profile picture, etc.), and the like. This may cause the intent messaging application to update the user interface 1108 to present the additional information associated with the user 1106 to the user associated with the other system 1104. For example, as illustrated in FIG. 11, the user interface 1108 is updated to present a profile picture and name of the user 1106 at the top of the communications session window, representing a title of the communications session window. Thus, the title of the communications session may be changed from the title of the intent provided to the user to the name and image of the user 1106. Further, any messages from the user 1106 presented via the communications session window may indicate the user's name and profile picture as opposed to the title of the intent.

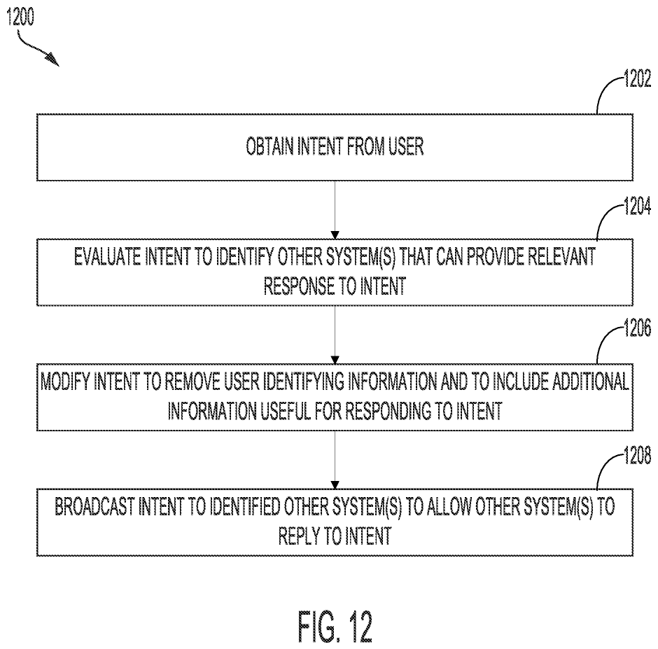

FIG. 12 shows an illustrative example of a process 1200 for broadcasting an intent to one or more other systems without providing identifying information associated with a user that submitted the intent in accordance with at least one embodiment. The process 1200 may be performed by an intent matching system of the intent messaging service, which may automatically process incoming intents submitted by users associated with the intent messaging service to identify other systems and/or other users to which these intents may be provided in order to solicit responses to the intents. As noted above, the intent matching system may implement an entity selection algorithm that is dynamically trained, in real-time, using sample intents and sample outputs corresponding to features of different systems and other users that may be used to identify the other systems and/or other users to which an intent is to be provided in order to solicit responses to the intent. Further, the entity selection algorithm may be dynamically trained in real-time using feedback from the different systems and other users receiving an intent. This feedback may be used to determine whether the entity selection algorithm is accurately selecting other systems and/or other users that are capable of responding to an intent with a relevant response or that are otherwise associated with a feature of an intent. This feedback may be used to further train the entity selection algorithm implemented by the intent matching system.

At step 1202, the intent matching system obtains an intent from a user associated with the intent messaging service. For instance, using an intent messaging application provided by the intent messaging service and implemented on a user's computing device, the user may generate a request to solicit one or more responses from different systems or other users within a network of users associated with the intent messaging service. In the request, the user may specify a name for the request, as well as provide their request that is to be associated with the provided name. The request may include an intent that may be used to identify other systems and/or other users that may be able to provide relevant responses to the user's request. Examples of intents can include (for example) topic, sentiment, complexity, and urgency. A topic can include, but is not limited to, a subject, a product, a service, a technical issue, a use question, a complaint, a refund request or a purchase request, etc. An intent can be determined, for example, based on a semantic analysis of a message (e.g., by identifying keywords, sentence structures, repeated words, punctuation characters and/or non-article words); user input (e.g., having selected one or more categories); and/or message-associated statistics (e.g., typing speed and/or response latency).

The intent messaging service may extract, from the request, an intent that may be used to identify other systems and/or other users that are likely to respond to the request with relevant information or responses that may be of use to the user. Further, the intent messaging service may associate the intent with a unique identifier that may be used to track the intent and any obtained responses to the intent. This may assist the intent messaging service in identifying responses to the intent from the various other systems and/or other users to which the intent is to be provided and with providing relevant responses from these other systems and/or users to the user. Additionally, the intent messaging service can solicit additional information from the user associated with the intent. For instance, the intent messaging service may utilize NLP, interactive voice recognition systems, and/or other forms of conversational voice algorithms and systems to prompt the user to provide this additional information. For instance, if the user has submitted a request for recommendations related to interior design companies, the intent messaging service may prompt the user to indicate where the user resides, what the timeframe is for completion of a new interior design project, what the budget is for a new interior design project, aspects of the interior design project, and to provide other information tied to the user's interior design query. The user, in response to these additional prompts from the intent messaging service, may provide the additional information that may be used to supplement the intent and identify other systems and other users that are likely to provide relevant responses to the user's intent.

In response to obtaining the intent from the user, the intent matching system, at step 1204, evaluates the intent to identify one or more other systems and/or other users that are likely to provide a relevant response to the intent. In an embodiment, the intent matching system, through the aforementioned entity selection algorithm, automatically identifies the one or more other systems and/or other users that are to be provided the intent in order to solicit responses from these one or more other systems and/or other users. The entity selection algorithm implemented by the intent matching system may utilize information corresponding to the other systems and other users from a system database and user database, respectively, maintained by the intent matching system, as well as the user's intent, as input to the entity selection algorithm to identify one or more other systems and/or one or more users that are likely to provide relevant responses to the extracted intent. The system database and user database may include profiles of each of the other systems and users, respectively, which may be associated with the intent messaging service. Each profile may indicate a user's or other system's experience responding to particular intents or categories of intents, as well as the user's or other system's interest in the underlying topic or classification of the intent. Further, each profile may indicate feedback with regard to a user's or other system's response to previously provided intents. This feedback may specify whether a response provided for a particular intent was relevant, useful, or otherwise appreciated by the user that submitted the request associated with the particular intent. The output produced by the entity selection algorithm implemented by the intent matching system may include identifiers corresponding to the other systems and/or other users to which the intent is to be provided in order to solicit responses to the request submitted by the user (e.g., the extracted intent) from these other systems and/or other users.

At step 1206, the intent matching system modifies the intent to remove any user identifying information and to include any additional information that may be of use to the identified other systems and/or other users for responding to the intent. As noted above, an intent may be provided to another system or other user anonymously, whereby the intent is presented without any identifying information of the user (e.g., user name, user contact information, user addresses, user images or pictures, etc.). This may prevent the other system or other user from sending unsolicited messages or responses to the user outside of the context of the intent. Thus, the intent matching system may evaluate the intent and remove any information that may be uniquely identify the user. Further, the intent matching system may supplement the intent with any of the information obtained by the intent messaging service from the user that may be useful to the other systems and/or other users that are to obtain the intent. This additional information may include a timeframe for resolution of the intent, a general (as opposed to specific, such as an address) geographic location associated with the user (e.g., city and state, etc.), a budget for resolution of the intent, and the like.

At step 1208, the intent matching system broadcasts the intent to the identified other systems and/or other users to allow these other systems and/or other users to reply to the intent. For instance, the intent matching system may transmit the intent to the intent messaging application of users associated with the identified other systems. This may cause the intent messaging application to update a communications session window associated with the intent messaging application to present a new panel corresponding to the intent. This may allow a user to select the intent from this new panel and access a communications session window corresponding to the intent. Through this communications session window, a user may generate and submit a response to the intent, which can be evaluated by the intent processing system of the intent messaging service. The intent may be assigned a unique identifier, which may be broadcast with the intent to the identified other systems and/or other users. Thus, responses to the intent may also be associated with this unique identifier. This may assist the intent processing system in providing intent responses for a particular intent to a user for their review.

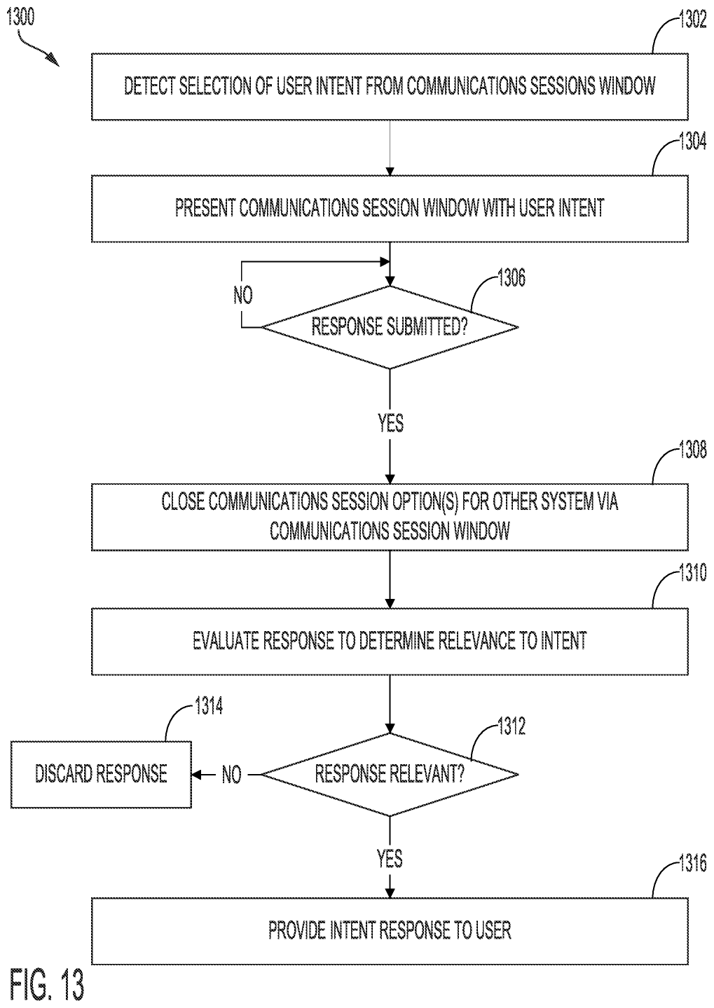

FIG. 13 shows an illustrative example of a process 1300 for obtaining an intent response from another system and evaluating the intent response to determine the relevance of the intent response to the intent in accordance with at least one embodiment. The process 1300 may be performed by an intent processing system of an intent messaging service. The intent processing system of the intent messaging service may automatically evaluate a response to an intent from another system to which the intent was provided in order to determine whether the response is relevant to the intent and can be provided to the user. In an embodiment, the intent processing system implements a response evaluation algorithm that is dynamically trained, in real-time, to evaluate responses from different systems and/or other users for different intents to determine whether these responses can be provided to users in response to these users' intents. Further, the intent processing system may interact with the intent messaging application utilized by a user associated with the other system to allow the user to provide a response to an intent and, subsequently, restrict further submission of responses until the user that has submitted the intent indicates that a communications session is to be established between the user and the other system.

At step 1302, the intent processing system, via the intent messaging application implemented on a computing device of a user associated with another system, detects selection of a user intent from a communications sessions window presented by the intent messaging application to the user. As noted above, when an intent submitted by a user is obtained by the intent messaging service, the intent messaging service, via an intent matching system, may identify one or more other systems and/or other users to which the intent may be provided in order to solicit intent responses from these one or more other systems and/or other users. In an embodiment, the intent messaging service, via an intent matching system, implements an entity selection algorithm that is dynamically trained, in real-time, to identify the one or more other systems and/or other users that are to be provided with the intent in order to solicit responses from these one or more other systems and/or other users. The entity selection algorithm implemented by the intent matching system may utilize information corresponding to the other systems and other users from a system database and user database, respectively, maintained by the intent matching system, as well as the user's intent, to identify one or more other systems and/or one or more users that are likely to provide relevant responses to the extracted intent. The system database and user database may include profiles of each of the other systems and users, respectively, which may be associated with the intent messaging service. Each profile may indicate a user's or other system's experience responding to particular intents or categories of intents, as well as the user's or other system's interest in the underlying topic or classification of the intent. Further, each profile may indicate feedback with regard to a user's or other system's response to previously provided intents. This feedback may specify whether a response provided for a particular intent was relevant, useful, or otherwise appreciated by the user that submitted the request associated with the particular intent.

As noted above, the entity selection may be dynamically trained in real-time using sample intents and corresponding sample outputs that may be used to identify the other systems and other users to which an intent is to be provided in order to solicit responses to the intent from these other systems and other users. Further, the entity selection algorithm may be dynamically trained in real-time using feedback from the different systems and other users receiving an intent. This feedback may be used to determine whether the entity selection algorithm is accurately selecting other systems and other users that are likely to provide, for the extracted intent, a relevant response or that are otherwise associated with a feature of the extracted intent. For example, if another system that provides interior design services obtained an intent that is not related to interior design, the other system may provide feedback indicating that the provided intent is not relevant to the other system. This feedback may be used to further train the entity selection algorithm.

The output of the entity selection algorithm described above may include an identifier corresponding to the other system. This may cause the intent messaging service to transmit the intent to a user associated with the other system to solicit an intent response from the user. The intent may be presented to the user via a communications session window of an intent messaging application implemented on a computing device of the user. Thus, through this communications sessions window, the user associated with the other system may select the intent submitted by the requesting user for review and to generate a response to the intent. The intent processing system, via the intent messaging application implemented on the computing device of the user, may detect this selection of the particular requesting user intent from the communications sessions window presented to the user via a user interface of the intent messaging application.

At step 1304, in response to detecting selection of the requesting user intent from the communications sessions window, the intent processing system may present, via the user interface of the intent messaging application implemented on the computing device of the user, a communications session window that includes the intent submitted by the requesting user. Through the communications session window, the user may view the intent submitted by the requesting user, as well as options for responding to the intent and for dismissing or ignoring the intent. In an embodiment, the intent submitted by the requesting user is presented devoid of any identifying information of the requesting user. For instance, the intent may be presented without the requesting user's name, the requesting user's contact information, the requesting user's images or pictures, or any other information that may be unique to the requesting user and usable to identify the requesting user. This ensures that the intent is presented anonymously to the user associated with the other system in order to preserve the privacy of the requesting user.

At step 1306, the intent processing system determines whether a response to the intent has been submitted by the user associated with the other system. The intent processing system may monitor, in real-time, communications from the intent messaging application implemented on the computing device of the user as these communications are submitted to identify any communications including a response to the requesting user's intent. For instance, if a user associated with the other system generates, via the communications session window associated with the intent, a response to the intent, the intent messaging application may transmit the response to the intent processing system. In an embodiment, the intent processing system awaits a response to a given intent for a limited period of time, after which the intent processing system determines that the other system has opted to forego providing a response to the intent. If this occurs, the intent processing system may transmit executable instructions to the intent messaging application implemented on the computing device of the user to remove the requesting user's intent from the communications sessions window and/or terminate the communication session window associated with the requesting user's intent. This may prevent the user from responding to the requesting user's intent after the limited period of time for a response has elapsed. In an alternative embodiment, the intent processing system can continue to await a response from the user to the intent until a response is submitted by the user or the requesting user has indicated that the intent has been resolved (e.g., by another system or other user).

If a response to the intent is provided by the user associated with the other system, the intent processing system, at step 1308, may transmit executable instructions to the intent messaging application implemented on the computing device of the user that, when executed by the intent messaging application, cause the intent messaging application to close the communications session options for the user associated with the other system via the communications session window. For instance, the executable instructions from the intent processing system may cause the intent messaging application to remove, from the communications session window, any options usable by the user associated with the other system to enter and submit responses to the presented intent. The intent messaging application may present the user with an indication that the communications session with the requesting user via the communications session window has been closed (e.g., as illustrated in FIG. 6, for example). The user may still be able to view, through the communications session window, the intent submitted by the requesting user and the intent response submitted by the user to the intent processing system. Further, the particular requesting user intent may still be accessible via the communications sessions window of the intent messaging application. It should be noted that, as an alternative to the intent processing system transmitting executable instructions to the intent messaging application to close the conversation options for the user, the intent messaging application may automatically close these conversation options in response to the user submitting a response to the requesting user intent via the communications session window.

At step 1310, the intent processing system evaluates the response submitted by the user to determine whether the response is relevant to the intent submitted by the requesting user. For instance, the intent processing system, through a response evaluation algorithm, may evaluate the response and classify the response as being either relevant to the intent or irrelevant to the intent. The response evaluation algorithm, in an embodiment, is dynamically trained, in real-time, using a dataset of input intents (e.g., historical intents associated with previously submitted requests, hypothetical intents, etc.), known relevant responses (e.g., historical responses deemed relevant by users that submitted associated requests/intents, hypothetical relevant responses for hypothetical intents, etc.), known irrelevant responses (e.g., historical responses rejected by users that submitted associated requests/intents, hypothetical irrelevant responses for the hypothetical intents, etc.), and corresponding classifications (e.g., historical classifications made in response to user feedback to provided responses, historical classifications made by an evaluator of historical responses submitted by other systems and other users, hypothetical classifications corresponding to hypothetical responses, etc.). Further, the response evaluation algorithm used to classify intent responses as being relevant or irrelevant may be dynamically trained in real-time using feedback from users. For instance, if a response classified as being relevant to an intent is provided to a requesting user, the requesting user may provide feedback indicating whether the response was indeed relevant to the intent. This feedback may be used to either reinforce the response evaluation algorithm (e.g., a response classified as being relevant was deemed relevant to the intent by a requesting user) or to update the response evaluation algorithm (e.g., a response classified as being relevant was deemed to be irrelevant to the intent by a requesting user). As users associated with the intent messaging service provide their feedback to the intent messaging service, the response evaluation algorithm may be dynamically updated in real-time

In some examples, the resulting classifications of the known relevant and irrelevant responses to the sample intents are evaluated to determine the loss, or error, that can be used to dynamically train the response evaluation algorithm. For instance, if the response evaluation algorithm classifies a relevant response to a sample intent as being an irrelevant response or classifies an irrelevant response to a sample intent as being a relevant response, the parameters of the response evaluation algorithm may be adjusted according to the loss resulting from the misclassification of the responses to the sample intents. These parameters may include weights and biases of the response evaluation algorithm implemented by the intent processing system.

In an embodiment, the response evaluation algorithm is also dynamically trained in real-time to identify characteristics or other features of a response, as well as the characteristics or other features of the intent for which the response was generated. These characteristics or features may be used to classify a response as either being relevant or irrelevant to an intent. For instance, if an intent includes one or more characteristics corresponding to an interior design request, the response evaluation algorithm may evaluate a response to the intent to determine whether the response includes one or more characteristics that also correspond to interior design. Based on a similarity among these characteristics, the response evaluation algorithm may automatically calculate a relevancy score that, if the relevancy score surpasses a relevancy threshold, may correspond to a relevant response. Thus, using the response evaluation algorithm, the intent processing system may evaluate a response and classify the response as being either relevant or irrelevant to a particular intent.

At step 1312, the intent processing system determines whether the intent response is relevant to the intent submitted by the requesting user. For instance, the intent processing system may use the output of the aforementioned response evaluation algorithm to determine whether the intent response has been classified as being relevant to the intent or irrelevant to the intent. If the intent processing system determines that the intent response is irrelevant to the intent, the intent processing system, at step 1314, automatically discards the intent response. In an embodiment, if the other system is identified as having provided an irrelevant response, the intent processing system can provide information regarding the other system, as well as the requesting user intent for which the other system was determined to have provided an irrelevant response, to the intent matching system. The intent matching system may utilize this information to further train the entity selection algorithm implemented to identify other systems and other users that may be selected for solicitation of responses to particular intents. This may result in the other system that provided an irrelevant response being less likely to be selected by the intent matching system to provide a response to an intent similar to the requesting user intent for which the other system or other user provided an irrelevant response.

If the intent processing system determines that the intent response provided by the user is relevant to the intent, the intent processing system, at step 1316, provides the intent response to the requesting user. For instance, the intent processing system may transmit the relevant response to the intent messaging application utilized by the requesting user, which may cause the intent messaging application to update a user interface to present the response to the requesting user via the requesting user's computing device. From this user interface, the requesting user may determine whether to initiate a communications session with the user associated with the other system that provided a relevant response. If the requesting user does not wish to initiate a communications session with the user that provided a response deemed to be relevant by the intent processing system, the requesting user may instead transmit a notification to the user via the intent messaging service thanking the user for their response. Additionally, or alternatively, the requesting user may submit feedback with regard to the obtained response. For instance, the requesting user may indicate whether the provided response was relevant to the intent submitted by the requesting user. This feedback may be used by the intent processing system to further train the response evaluation algorithm implemented to identify relevant responses to given intents. If the requesting user opts to initiate a communications session with the user, the intent messaging service may establish the communications session between the requesting user and the user associated with the other system. This allows the user associated with the other system to interact with the requesting user over the communications session.

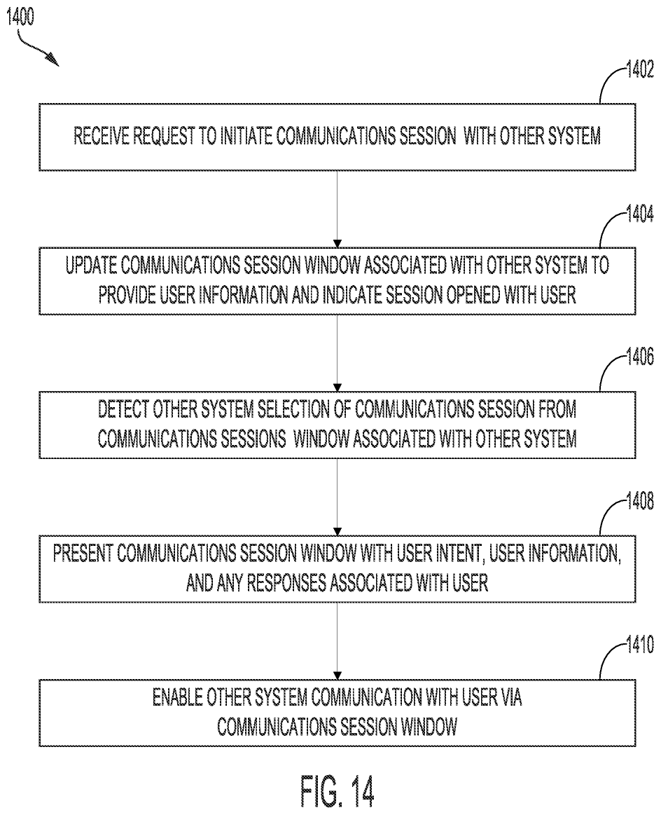

FIG. 14 shows an illustrative example of a process 1400 for establishing a communications session between a requesting user and another system in response to a request from the requesting user to initiate a communications session with the other system in accordance with at least one embodiment. The process 1400 may be performed by the intent messaging service, which may utilize the intent processing system to establish the communications session between a computing device of a requesting user and a computing device of a user associated with a particular other system in response to a request from the requesting user to initiate a communications session with the other system for a particular intent. For instance, if a requesting user determines that an intent response from another system is relevant to the intent submitted by the requesting user to the intent messaging service and that further communications with regard to the intent is desired, the requesting user can submit a request to the intent messaging service to initiate a communications session with this other system with regard to the intent.

At step 1402, the intent messaging service receives a request to initiate a communications session with a particular other system. As noted above, in response to obtaining an intent response from another system, the requesting user may opt to initiate a communications session with a user associated with the other system to further discuss the intent and the intent response submitted by the user associated with the other system via the intent messaging service. Through a user interface of an intent messaging application implemented on a computing device of the requesting user, the requesting user may select the intent response and indicate that the requesting user desires to initiate a communications session with the user that supplied the intent response. This may cause the intent messaging application to generate a request to the intent messaging service to establish a communication session between the computing device of the requesting user and the computing device of the user that submitted the intent response in order to allow for the exchange of communications between the user associated with the other system and the requesting user. The request may include a unique identifier corresponding to the requesting user intent, as well as other identifying information of the user associated with the brand and/or the intent response itself.

In response to receiving the request from the intent messaging application utilized by the requesting user, at step 1404, the intent messaging service, via the intent processing system, updates the communications sessions window of the intent messaging application utilized by the user associated with the other system to provide additional information of the requesting user and to indicate that a communications session has been established with the requesting user. For instance, the intent processing system may update the communications sessions window to provide the requesting user's name, a requesting user's image or picture, a requesting user's contact information (e.g., e-mail address, physical address, telephone number, etc.), and the like. Further, via the communications sessions window, the intent processing system can change a panel associated with the intent response submitted by the user associated with the other system to indicate that a communications session has been established between the requesting user and the user. This change may include, for example, a change in the color of the panel, a textual statement indicating that the communications session has been established between the requesting user and the user, an auditory indication that the communications session has been established between the requesting user and the user (e.g., a chime, an audial statement, etc.), and the like. As a result of the change to the communications sessions window of the intent messaging application utilized by the user associated with the other system, the user may select the panel corresponding to this communications session to access a communications session window corresponding to the communications session between the requesting user and the user associated with the other system.

At step 1406, the intent processing system detects selection of a communications session from the communications sessions window by a user associated with the other system. For instance, if a user selects, using the user interface of the intent messaging application implemented on a computing device of the user associated with the other system, a panel corresponding to the intent response previously submitted to the requesting user, the intent messaging application may determine that the user has submitted a request to access a communications session window for the intent submitted by the requesting user. In an embodiment, if the requesting user has not provided an indication that a communications session is to be initiated between the requesting user and the user associated with the other system, the communications session window corresponding to the intent may be disabled, whereby the user associated with the other system may be prohibited from submitting additional intent responses to the intent submitted by the requesting user. However, if the requesting user has indicated that a communications session between the requesting user and the user associated with the other system is to be initiated, and the intent messaging application detects selection of the panel corresponding to the intent submitted by the requesting user, the intent messaging application may transmit a request to the intent processing system to obtain any messages submitted by the requesting user in response to the intent response submitted by the user associated with the other system and that can be presented within the communications session window corresponding to this intent.

At step 1408, the intent processing system, via the intent messaging application implemented on a computing device of the user associated with the other system, presents a communications session window through which the requesting user intent, requesting user information, and responses from the requesting user to the intent response submitted by the user may be displayed. For instance, via the user interface of the intent messaging application utilized by the user associated with the other system, a communications session window may be presented that includes the original intent submitted by the requesting user and the corresponding intent responses submitted by the user to the intent messaging service. Further, the communications session window may be updated to include the name of the requesting user, an image or other picture of the requesting user, and the responses submitted by the requesting user to the intent response submitted by the user associated with the other system via the user interface of the intent messaging application utilized by the requesting user.

In an embodiment, the intent processing system, in response to detecting the selection of the communications session panel corresponding to this intent and intent response, establishes the communications session between the requesting user and the user associated with the other system. Thus, the presentation of the communications session window may cause the intent processing system, at step 1410, to enable the user associated with the other system to communicate with the requesting user via the communications session window and the newly established communications session. As noted above, when a user associated with another system submits an intent response to a particular intent, the intent processing system may prohibit or otherwise restrict the user from submitting additional intent responses or other communications to the requesting user. This may prevent the user from submitting unsolicited messages or otherwise inundate a requesting user with irrelevant responses to a particular intent. By establishing the communications session between the requesting user and the user, the intent processing system may remove this restriction and allow the user to engage the requesting user via the communications session established for the specific intent.

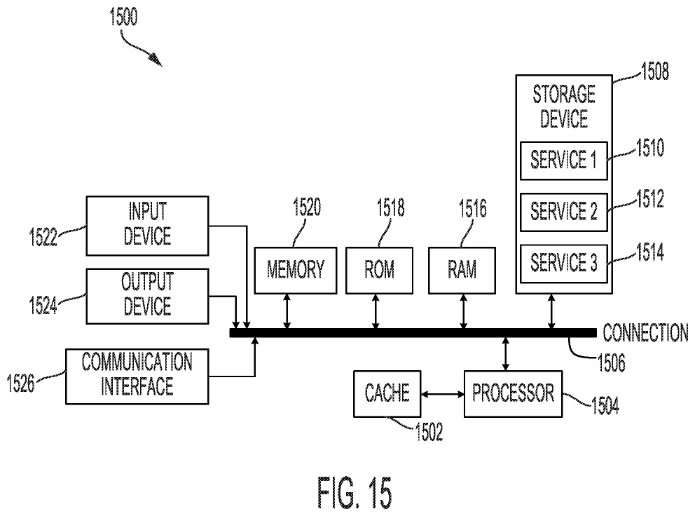

FIG. 15 illustrates a computing system architecture 1500 including various components in electrical communication with each other using a connection 1506, such as a bus, in accordance with some implementations. Example system architecture 1500 includes a processing unit (CPU or processor) 1504 and a system connection 1506 that couples various system components including the system memory 1520, such as ROM 1518 and RAM 1516, to the processor 1504. The system architecture 1500 can include a cache 1502 of high-speed memory connected directly with, in close proximity to, or integrated as part of the processor 1504. The system architecture 1500 can copy data from the memory 1520 and/or the storage device 1508 to the cache 1502 for quick access by the processor 1504. In this way, the cache can provide a performance boost that avoids processor 1504 delays while waiting for data. These and other modules can control or be configured to control the processor 1504 to perform various actions.

Other system memory 1520 may be available for use as well. The memory 1520 can include multiple different types of memory with different performance characteristics. The processor 1504 can include a general-purpose processor and a hardware or software service, such as service 1 1510, service 2 1512, and service 3 1514 stored in storage device 1508, configured to control the processor 1504 as well as a special-purpose processor where software instructions are incorporated into the actual processor design. The process 1504 can alternatively include a special-purpose processor and a hardware or software service configured to control the process 1504. The processor 1504 may be a completely self-contained computing system, containing multiple cores or processors, a bus, memory controller, cache, etc. A multi-core processor may be symmetric or asymmetric.

To enable user interaction with the computing system architecture 1500, an input device 1522 can represent any number of input mechanisms, such as a microphone for speech, a touch-sensitive screen for gesture or graphical input, keyboard, mouse, motion input, speech and so forth. An output device 1524 can also be one or more of a number of output mechanisms known to those of skill in the art. In some instances, multimodal systems can enable a user to provide multiple types of input to communicate with the computing system architecture 1500. The communications interface 1526 can generally govern and manage the user input and system output. There is no restriction on operating on any particular hardware arrangement and therefore the basic features here may easily be substituted for improved hardware or firmware arrangements as they are developed.

Storage device 1508 is a non-volatile memory and can be a hard disk or other types of computer readable media which can store data that are accessible by a computer, such as magnetic cassettes, flash memory cards, solid state memory devices, digital versatile disks, cartridges, RAMs 1516, ROM 1518, and hybrids thereof.

The storage device 1508 can include services 1510, 1512, 1514 for controlling the processor 1504. Other hardware or software modules are contemplated. The storage device 1508 can be connected to the system connection 1506. In one aspect, a hardware module that performs a particular function can include the software component stored in a computer-readable medium in connection with the necessary hardware components, such as the processor 1504, connection 1506, output device 1524, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages. However, it should be noted that the algorithms and displays presented herein can be implemented using various special-purpose systems that may be used with programs in accordance with the teachings herein.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, special purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, special purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
obtaining an intent, wherein the intent is associated with a requesting user;
generating in real-time a dataset, wherein the dataset includes sample intents, sample outputs, and feedback corresponding to the sample outputs, wherein the sample outputs correspond to features associated with a set of other users that are provided with the sample intents, and wherein the dataset is generated in real-time as the feedback is obtained;
dynamically training in real-time a machine learning algorithm to identify different users for soliciting responses to different intents, wherein the machine learning algorithm is dynamically trained using the dataset as the feedback is obtained;
processing the intent through the machine learning algorithm to identify one or more users for soliciting responses to the intent;
obtaining in real-time an intent response, wherein the intent response is associated with a particular user from the one or more users;
providing the intent response, wherein the intent response is provided as a result of a determination that the intent response is relevant to the intent;
facilitating a communications session between the requesting user and the particular user, wherein the communications session is facilitated in response to input corresponding to the intent response;
dynamically updating the dataset in real-time using the intent and features corresponding to particular user; and
updating in real-time the machine learning algorithm using the dynamically updated dataset.

2. The computer-implemented method of claim 1, wherein the intent is provided without identifying information associated with the requesting user, and wherein when the communications session is facilitated, the identifying information associated with the requesting user is provided.

3. The computer-implemented method of claim 1, further comprising:
performing a semantic analysis of a request associated with the requesting user to extract the intent from the request.

4. The computer-implemented method of claim 1, further comprising:
identifying additional information for supplementing the intent; and
submitting one or more prompts for the additional information, wherein when the one or more prompts are presented through a computing device associated with the requesting user, the additional information is provided.

5. The computer-implemented method of claim 1, further comprising:
transmitting a set of executable instructions, wherein when the set of executable instructions are received by an application associated with the particular user, the application automatically prohibits the particular user from submitting additional intent responses.

6. The computer-implemented method of claim 1, further comprising:
obtaining in real-time a different intent response, wherein the different intent response is associated with a different user from the one or more users;
determining that the different intent response is irrelevant to the intent; and
dynamically updating the dataset in real-time such that a likelihood of the different user being identified by machine learning algorithm for similar intents is reduced.

7. The computer-implemented method of claim 1, further comprising:
dynamically training in real-time a classification algorithm to classify intent responses as being either relevant or irrelevant to corresponding intents, wherein the classification algorithm is dynamically trained using a dataset of input intents, known responses, and classifications corresponding to the known responses; and
processing the intent and the intent response through the classification algorithm, wherein when the intent and the intent response are processed, the classification algorithm classifies the intent response as being relevant to the intent.

8. A system, comprising:
one or more processors; and
memory storing thereon instructions that, as a result of being executed by the one or more processors, cause the system to:
obtain an intent, wherein the intent is associated with a requesting user;
generate in real-time a dataset, wherein the dataset includes sample intents, sample outputs, and feedback corresponding to the sample outputs, wherein the sample outputs correspond to features associated with a set of other users that are provided with the sample intents, and wherein the dataset is generated in real-time as the feedback is obtained;
dynamically train in real-time a machine learning algorithm to identify different users for soliciting responses to different intents, wherein the machine learning algorithm is dynamically trained using the dataset as the feedback is obtained;
process the intent through the machine learning algorithm to identify one or more users for soliciting responses to the intent;
obtain in real-time an intent response, wherein the intent response is associated with a particular user from the one or more users;
provide the intent response, wherein the intent response is provided as a result of a determination that the intent response is relevant to the intent;
facilitate a communications session between the requesting user and the particular user, wherein the communications session is facilitated in response to input corresponding to the intent response;
dynamically update the dataset in real-time using the intent and features corresponding to particular user; and
update in real-time the machine learning algorithm using the dynamically updated dataset.

9. The system of claim 8, wherein the intent is provided without identifying information associated with the requesting user, and wherein when the communications session is facilitated, the identifying information associated with the requesting user is provided.

10. The system of claim 8, wherein the instructions further cause the system to:
perform a semantic analysis of a request associated with the requesting user to extract the intent from the request.

11. The system of claim 8, wherein the instructions further cause the system to:
identify additional information for supplementing the intent; and
submit one or more prompts for the additional information, wherein when the one or more prompts are presented through a computing device associated with the requesting user, the additional information is provided.

12. The system of claim 8, wherein the instructions further cause the system to:
transmit a set of executable instructions, wherein when the set of executable instructions are received by an application associated with the particular user, the application automatically prohibits the particular user from submitting additional intent responses.

13. The system of claim 8, wherein the instructions further cause the system to:
obtain in real-time a different intent response, wherein the different intent response is associated with a different user from the one or more users;
determine that the different intent response is irrelevant to the intent; and
dynamically update the dataset in real-time such that a likelihood of the different user being identified by machine learning algorithm for similar intents is reduced.

14. The system of claim 8, wherein the instructions further cause the system to:
dynamically train in real-time a classification algorithm to classify intent responses as being either relevant or irrelevant to corresponding intents, wherein the classification algorithm is dynamically trained using a dataset of input intents, known responses, and classifications corresponding to the known responses; and
process the intent and the intent response through the classification algorithm, wherein when the intent and the intent response are processed, the classification algorithm classifies the intent response as being relevant to the intent.

15. A non-transitory, computer-readable storage medium storing thereon executable instructions that, as a result of being executed by one or more processors of a computer system, cause the computer system to:
obtain an intent, wherein the intent is associated with a requesting user;
generate in real-time a dataset, wherein the dataset includes sample intents, sample outputs, and feedback corresponding to the sample outputs, wherein the sample outputs correspond to features associated with a set of other users that are provided with the sample intents, and wherein the dataset is generated in real-time as the feedback is obtained;
dynamically train in real-time a machine learning algorithm to identify different users for soliciting responses to different intents, wherein the machine learning algorithm is dynamically trained using the dataset as the feedback is obtained;
process the intent through the machine learning algorithm to identify one or more users for soliciting responses to the intent;
obtain in real-time an intent response, wherein the intent response is associated with a particular user from the one or more users;
provide the intent response, wherein the intent response is provided as a result of a determination that the intent response is relevant to the intent;
facilitate a communications session between the requesting user and the particular user, wherein the communications session is facilitated in response to input corresponding to the intent response;
dynamically update the dataset in real-time using the intent and features corresponding to particular user; and
update in real-time the machine learning algorithm using the dynamically updated dataset.

16. The non-transitory, computer-readable storage medium of claim 15, wherein the intent is provided without identifying information associated with the requesting user, and wherein when the communications session is facilitated, the identifying information associated with the requesting user is provided.

17. The non-transitory, computer-readable storage medium of claim 15, wherein the executable instructions further cause the computer system to:
perform a semantic analysis of a request associated with the requesting user to extract the intent from the request.

18. The non-transitory, computer-readable storage medium of claim 15, wherein the executable instructions further cause the computer system to:
identify additional information for supplementing the intent; and
submit one or more prompts for the additional information, wherein when the one or more prompts are presented through a computing device associated with the requesting user, the additional information is provided.

19. The non-transitory, computer-readable storage medium of claim 15, wherein the executable instructions further cause the computer system to:
transmit a particular set of executable instructions, wherein when the particular set of executable instructions are received by an application associated with the particular user, the application automatically prohibits the particular user from submitting additional intent responses.

20. The non-transitory, computer-readable storage medium of claim 15, wherein the executable instructions further cause the computer system to:
obtain in real-time a different intent response, wherein the different intent response is associated with a different user from the one or more users;
determine that the different intent response is irrelevant to the intent; and
dynamically update the dataset in real-time such that a likelihood of the different user being identified by machine learning algorithm for similar intents is reduced.

21. The non-transitory, computer-readable storage medium of claim 15, wherein the executable instructions further cause the computer system to:
dynamically train in real-time a classification algorithm to classify intent responses as being either relevant or irrelevant to corresponding intents, wherein the classification algorithm is dynamically trained using a dataset of input intents, known responses, and classifications corresponding to the known responses; and
process the intent and the intent response through the classification algorithm, wherein when the intent and the intent response are processed, the classification algorithm classifies the intent response as being relevant to the intent.
